(19) United States
(12) Patent Application Publication
(10) Pub. No.: US 2025/0021348 A1
(43) Pub. Date: Jan. 16, 2025

(54) HASH VALUE FILTERING FOR CONTROL FLOW INTEGRITY

(71) Applicant: Cisco Technology, Inc., San Jose, CA (US)

(72) Inventors: Ashok Krishnaji Moghe, Pleasanton, CA (US); Andrew Zawadowskiy, Hollis, NH (US); Oleg Bessonov, Littleton, MA (US)

(21) Appl. No.: 18/221,833

(22) Filed: Jul. 13, 2023

(51) Int. Cl. G06F 9/448

(52) U.S. Cl. CPC G06F 9/448

(57) ABSTRACT

Techniques and systems described herein relate to monitoring executions of computer instructions on computing devices based on observing and generating a control flow directed graph. The techniques and systems include determining an observation phase for a process or application on a computing device. During the observation phase, CPU telemetry is determined and used to generate a control flow directed graph. After the control flow directed graph is generated, a hash table associated with frequently traversed execution paths is generated. A monitoring phase may be entered where transfers of instruction pointers are monitored based on the control flow directed graph to identify invalid transfers. The frequently traversed execution paths may be identified based on the hash table and be identified as valid if the hash value corresponds to the table.

### TECHNICAL FIELD

The present disclosure relates generally to detection and protection against computer system attacks.

### BACKGROUND

Malicious software, also known as malware, affects a great number of computer systems worldwide. In its many forms such as computer viruses, worms, rootkits, unsolicited adware, ransomware, and spyware, malware presents a serious risk to millions of computer users, making them vulnerable to loss of data and sensitive information, identity theft, and loss of productivity, among others. Malware may further display material that is considered by some users to be obscene, excessively violent, harassing, or otherwise objectionable.

A particular kind of malware consists of a code reuse attack. Some examples of such malware and attack include return-oriented programming (ROP), jump-oriented programming (JOP), call-oriented programming (COP), counterfeit object-orient programming (COOP), and other variations of code reuse exploits. A typical ROP exploit, also known in the art as a return-into-library attack, includes an illegitimate manipulation of a call stack used by a thread of a process, the illegitimate manipulation intended to alter the original functionality of the respective thread/process. For instance, an exemplary ROP exploit may manipulate the call stack so as to force the host system to execute a sequence of code snippets, known as gadgets, each such gadget representing a piece of legitimate code of the target process. Careful stack manipulation may result in the respective code snippets being executed in a sequence, which differs from the original, intended sequence of instructions of the original process or thread.

By re-using pieces of code from legitimate processes to carry out malicious activities instead of explicitly writing malicious code, ROP/JOP/COP/COOP exploits may evade detection by conventional anti-malware techniques. Several anti-malware methods have been proposed to address code-reuse attacks, but such methods typically place a heavy computational burden on the respective host system, negatively impacting user experience. Therefore, there is a strong interest in developing systems and methods capable of effectively targeting code reuse malware, with minimal computational costs.

Control flow integrity (CFI) validation techniques may provide a defense against control flow hijacking attacks. CFI validation techniques are configured to guarantee legitimate control flow transfers in an application. Existing CFI validation techniques may require source code modification and/or binary re-instrumentation to insert run time CFI checks in an application binary. Further, existing CFI validation techniques may incur a performance penalty and/or may provide only a limited history, thus, limiting accuracy.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example system architecture for control flow monitoring using an observed control flow graph, according to at least one execution example.

FIG. 2 illustrates an example control flow monitor architecture, according to at least one execution example.

FIG. 3 illustrates an example system architecture for a software and hardware accelerated system to observe and monitor application executions, according to at least one execution example.

FIG. 4 illustrates an example of a control flow graph used for monitoring application executions, according to at least one execution example.

FIG. 5 illustrates an example of a process for generating hash values for filtering control flow execution sequences, according to at least one execution example.

FIG. 6 illustrates an example of a control flow graph showing a vector of execution with an associated hash value for accelerating enforcement of the control flow graph, according to at least one execution example.

FIG. 7 illustrates an example system architecture for distributed monitoring agents on devices of a network or system with a centralized monitoring control plane, according to at least one execution example.

FIG. 8 illustrates an example of multiple different monitoring control planes reporting to a centralized cloud-based system for identifying large-scale patterns and exploits, according to at least one execution example.

FIG. 9 illustrates an example process for enforcing execution according to an observed control flow directed graph using hash value filtering, according to at least one execution example.

FIG. 10 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

The present disclosure relates generally to detection and protection against computer system attacks. In particular, the techniques and systems described herein relate to monitoring executions of computer instructions on computing devices based on observing and generating a control flow directed graph. The techniques and systems are capable of determining an observation phase for a process or application on a computing device. During the observation phase, CPU telemetry is determined and used to generate a control flow directed graph. After the control flow directed graph is generated, a hash table associated with frequently traversed paths is generated. A monitoring phase may be entered where transfers of instruction pointers are monitored based on the control flow directed graph to identify invalid transfers. The frequently traversed paths may be identified based on the hash table and be identified as valid if the hash value for the paths is stored and/or contained within the table. Systems and components are described herein to implement the techniques in various environments.

### EXAMPLE EMBODIMENTS

The present disclosure relates generally to sing telemetry from a computing device to do control flow directed graph security monitoring of workloads on bare metal, virtual machines, or containers. The control flow directed graph is generated by observing executions over an observation period and subsequently entering an enforcement mode wherein the observed control flow directed graph is used to monitor and prevent execution of unobserved or otherwise restricted actions.

A control flow directed graph (CFDG), sometimes referred to herein as a control flow diagram, is a representation, using graph notation, of control flow, i.e., execution, paths that may be traversed through an application during execution of the application. In a control flow graph, each node in the graph corresponds to a basic block. A basic block is a sequence of instructions where control enters at the beginning of the sequence. For example, a destination address, may correspond to a start of a basic block and an indirect branch instruction may correspond to an end of the block. A target address of the indirect branch instruction may correspond to a next possible address of a next basic block in the CFDG, i.e., may correspond to a beginning address of a next/reachable basic block in the CFDG. Edges between two basic blocks (e.g., a first block and a second block) represent control flow transfer from the end of the first block to the beginning of the second block. A node may thus include a start address of the basic block, and a next possible start address of a next basic block i.e., a beginning address of a next/reachable basic block that may be stored as part of the graph edge connecting a first node to a second node. A control flow graph may be generated by, for example, observation during an observation phase (as described herein, by observing CPU telemetry), source code analysis, binary analysis, static binary analysis, execution profiling, etc. The control flow graph may then include a plurality of legitimate transitions. Each legitimate execution path may include a plurality of nodes connected by one or more edges from a start node.

Control flow integrity (CFI) validation techniques are configured to enforce a CFI security policy that execution of an application follow a legitimate path of a CFDG. CFI validation techniques may thus be used to mitigate control flow hijack attacks. Generally, CFI validation is configured to validate a control flow transfer and/or an execution path at indirect or conditional branches, determined at runtime, against a legitimate CFDG, determined prior to runtime. As used herein, indirect branch instructions include, but are not limited to, jump instructions, function calls, function returns, interrupts, etc., that involve updating the instruction pointer from a register or a memory location. Some CFI validation techniques rely on source code modification or binary re-instrumentation to insert run time CFI checks into the application binary.

Zero-day attacks area prolific problem throughout the software industry and generally relate to recently discovered security vulnerabilities that malicious actors can use to attack systems. Zero-day refers to the fact that the developer has only just learned of the flaw and has zero days to fix the vulnerability. Zero-day attacks take place when the malicious actors exploit the vulnerability before the developer has a chance to address it. Very few products address Zero-day threats before the exploit vector is widely known. A vulnerability remains unknown for an average of about two hundred days. Even after the vulnerability is widely known, patching every system within an enterprise may take months or even years to complete. Older systems may even remain vulnerable in perpetuity because a patch is not available, or the patch negatively affects the system in some way.

Finding threats after they have been exploited is unlikely to be adequate as attackers often pivot from the initial attack to other systems. Therefore, even if a known vulnerability is patched, the attacker may have already exploited the issue to move laterally to another machine or workload. Once an attacker has successfully exploited a systems, they may be within the enterprise, and therefore it is critical to identify such vulnerabilities before they are exploited and prevent attackers from exploiting the vulnerabilities.

The system and technologies described herein use CFDG to monitor the actual execution and instruction stream of the application process. This system provides true Control Flow Integrity (CFI) of the application. The systems and methods described herein leverage hardware telemetry so that the actual executions can be effectively and accurately monitored. The techniques described herein will work on a variety of hardware-based solutions, where we are able to reliably detect even the most sophisticated code reuse attacks using (ROP, COP, JOP, COOP etc.) gadgets.

This disclosure describes techniques for using hardware telemetry to perform CFDG monitoring of cloud-native workloads running on bare metal, virtual machines (VMs), or containers. The techniques described herein include a capability to allow the use of this hardware assisted approach to be applied to virtual machines and to containerized workloads as well as local bare metal implementations.

In an example, the systems and methods described herein use a hardware-assisted technology to apply the CFDG to monitor critical systems, virtual machines, and containerized workloads. The systems and techniques described herein provide for secure (detecting most advance code reuse attacks that trigger at least one invalid transition) workload execution monitoring in real-time allowing for the enforcement of the intended operations of the workloads to be done in a secure manner. The systems and techniques described herein leverage hardware telemetry available in both Intel® and ARM® processors as well as other such technologies. Using CPU telemetry, the system may be able to transparently monitor execution of any process of interest, whether these processes are running on bare metal, within virtual machines, or inside of containers. Given an observed control flow graph for the process being monitored, the techniques and systems described herein are able to detect the most advance code-reuse attacks by observing invalid transfers of the instruction pointer to attacker-selected code gadgets. These attacks can be difficult to detect, for example through system-call monitoring because modern applications have a large number of system calls, so attacker code or vulnerabilities can do a lot of damage and still easy maintain a completely valid system-call profile. The systems and methods described herein leverage CPU control flow telemetry, which could be represented as a CFDG, bloom filter lookup table, a machine learning model, or any number of other potential embodiments.

During deployment of the systems and methods described herein, two main phases can be employed, observation as a first phase and monitoring and/or enforcement as a second phase following the first phase. In some instances, the monitoring and/or enforcement phases occur during a second phase, after the observation phase. In some scenarios these two phases can be done together. In the observation phase, the application or workload may be executed as normal, such as during a trial phase or initial setup phase. The observation phase may include observing executions based on the CPU telemetry and building the CFDG based on observed executions. In this manner, the CFDG is an observed CFDG built based on observed executions by the application or within the workload. After some predetermined period of time (e.g., seconds, minutes, days, weeks, etc.) and/or based on coverage on an amount of the code of the application or workload (e.g., when the observed code used to build the observed CFDG reaches a threshold such as 50%, 60%, 70%, 80%, 90%, etc.), then the observation phase may automatically be completed. In some examples, the observation phase may be monitored by a security team who may determine when to exit the observation phase and enter a monitoring phase.

In the monitoring phase, the executions based on the CPU telemetry may be compared against the observed CFDG to identify deviations from the observed CFDG and thereby identify potential code reuse attacks or other potential exploits before they can be executed. In some examples, only observed transitions during the observation period will be allowed to execute, and others may be treated as invalid transfers and either cause a default action (e.g., cancel the execution), remedial action, or identify further information (e.g., the sequence that led to the invalid request to determine if the request should be valid based on a valid sequence leading to the request). The monitoring may be locally performed, performed using a cloud-based system using a monitoring agent at the local device, monitored on a network, or otherwise implemented.

The monitoring system described herein is an observation-based enforcement system that uses CPU observability outside of the workload itself. Accordingly, the underlying code does not need to me modified, but instead, observations are performed on unmodified workloads and after the observation period ends, monitoring and/or enforcement of the observed CFDG is done during deployment of the workload.

The systems and methods described herein do not require static analysis of the workload to take place during a build as all binary analysis is done at runtime on un-instrumented and unmodified workloads. Typical systems for monitoring workload executions use some type of code instrumentation, hooks, or injection techniques in order to operate. By contrast, the systems and methods described herein are entirely non-invasive to the workloads themselves, relying solely on CPU observations to build the execution containment system. The binary itself contains all of the compiled instructions to determine a code coverage percentage that is achieved during observation. Accordingly, the system is able to ascertain the amount of total binary code has been observed in terms of total code coverage of possible execution paths.

The monitoring and enforcement system described herein may include further refinements, such as described herein, to improve performance (e.g., speed) of evaluating the compliance of the executions with the CFDG. For example, the control flow graph may include paths that are frequently traversed (e.g., major paths such as function calls that follow particular branches within the CFDG) and paths and/or branches that are less frequently traversed (e.g., loops and conditional branches). Within the frequently traversed paths, the major paths, most applications, and processes will traverse a similar or repeated path frequently, meaning the application will follow one or more sequences of executions in the exact same order a large number of times. The monitoring and enforcement engine may use this repetitive sequence of executions to filter functions out and speed up the monitoring of executions by identifying such frequently traversed sequences.

In some examples, a hardware filtering function may use a rolling hash of the major functions. Since the applications will traverse one or more paths repeatedly, this hardware filter may filter out valid transitions by comparing the hash value against a learned or observed hash value associated with the one or more paths without having to compare each transition within the sequence. In the event that the hash of the currently observed transition doesn't match the learned and/or stored hash value then the monitoring and enforcement engine will inspect the individual branches taken during the sequence against the observed CFDG and may determine that the execution is progressing still within the bounds of the learned CFDG.

After the observation period, a typical application execution will most likely follow one or more of the same major paths. In some examples, a hardware assistance engine may be used to calculate a rolling hash token for these major path transitions. This may compress a sequence of transitions into a smaller group for processing rather than processing an entire set of sequences. During the observation phase, and/or during the enforcement phase, the monitoring and enforcement engine may build a table of hash values for such major paths. Subsequently, a filter running in either hardware or software may verify or compare the hash values from the rolling hash against the table to speed up the monitoring of executions. This improvement enhances the performance of the monitoring and enforcement engine by capitalizing on the fact that under normal circumstances applications will be traversing a small number of repeated and valid subgraphs.

In an example, when processing CPU real-time processer trace packets and matching them against observed control flow graph there are two stages of processing that occur. A first stage is a decoding stage where telemetry packets are decoded from a stream of packets. During the decoding stage, information about the instruction pointer transition is acquired in a form of a tuple of two virtual addresses that correspond to source (FROM) and destination (TO) of the transition. A second stage includes checking the validity of (FROM, TO) a transition by looking up the addresses in the observed control flow graph. For all valid transitions there is an edge in the CFDG that connects source and destination of the transition. By accelerating the lookup and checking of validity of a transition, as described herein, the entire process for monitoring and enforcing the CFDG is accelerated.

In the example, each lookup in the CFDG may be an expensive operation (e.g., expensive with respect to time and computing resources). Checking the presence of the edge requires de-referencing a pointer or making a lookup in a hash table. Considering the large number of edges, this operation may require looking into memory that is not loaded in cache. Based on the large number of transitions per second in any given application, it would considerably slow down the processing to look up all of the edges.

To accelerate the processing, the number of lookups per transition is reduced. Using the observed CFDG, the system may identify that some paths in the control flow are traversed more frequently than others. Therefore, looking up the entire paths instead of a singular transition decreases the number of lookups per transition in the control flow, and thereby increases the speed of monitoring and enforcement.

In the example, the CPU may report a sequence of instruction addresses, A₁, A₂, . . . , A_{M}. These addresses correspond to M−1 transitions: (A₁→A₂), (A₂→A₃), . . . , (A_{M-1}, →A_{M}). Each subsequence of sequence of addresses is also a valid sequence. The monitoring and enforcement engine may verify sequences of size 2, which correspond to a single transition. Increasing size of the sequence reduces the number of hash table lookups and thereby increases the speed of monitoring and enforcement.

During observation phase, the system may count all subsequences and compute their associated hash. Due to memory limitations and reduced effectiveness for very long sequences, in some examples the maximum length of the subsequence may be limited to some finite number greater than two. When the observation phase is finished, subsequence counts are used to compute probability distribution of subsequences given the size of the subsequence: P([Aᵢ_{₁}, Aᵢ_{₂}, . . . , Aᵢ_{_{N}}] IN), where N is the size of subsequence, 2≤N≤L. The probability distribution determined based on the start node of the sequence can be computed using equation Error! Reference source not found. below.

$$P ( [ {A}_{start} , {A}_{{i}_{2}} , … , {A}_{{i}_{N}} ] \vert {A}_{start} , N ) = \frac{P ( [ {A}_{start ,} {A}_{{i}_{2}} , … , {A}_{{i}_{N}} ] \vert N )}{\sum {∀}_{{j}_{2 , … , {j}_{N}}} P ( [ {A}_{start ,} {A}_{{j}_{2}} , … , {A}_{{j}_{N}} ] \vert N )} \qquad ( 1 )$$

The probability distribution may be further reduced to a probability distribution of hashes of a sequence conditioned on start address and size of sequence as shown in equation (2) below.

$$P ( hash \vert {A}_{start} , N ) = P ( hash ( [ {A}_{start} , {A}_{{i}_{2}} , … , {A}_{{i}_{N}} ] ) \vert {A}_{start} , N ) = P ( [ {A}_{start} , {A}_{{i}_{2}} , … , {A}_{{i}_{N}} ] \vert {A}_{start} , N ) \qquad ( 2 )$$

Using the probability distribution, the most likely set of hashes can be determined based on a combination of start address and sequence size. The most likely set of hashes (LikelyHash_{S}(Aₛₜₐᵣₜ,N)) can be arranged in an array of hashes with the likelihood of sequences that start with a particular address is distribution, the most likely hashes can be calculated for each combination of start address, Aₛₜₐᵣₜ, and have sequence size of N. The array may be arranged with the sequence having the greatest likelihood entered first, and proceed with decreasing probability

A hash table, AddressStat, may be constructed that maps start nodes, Aₛₜₐᵣₜ, to likely hashes of sequences starting with Aₛₜₐᵣₜ and a list of addresses immediately reachable from Aₛₜₐᵣₜ as shown in equation (3) below.

$$AddressStat [ {A}_{start} ] \to \{ \begin{matrix}\begin{matrix}\begin{matrix}[ {LikelyHash}_{S} ( {A}_{start} , L ) , \\ {LikelyHash}_{S} ( {A}_{start} , L - 1 ) , … ,\end{matrix} \\ {LikelyHash}_{S} ( {A}_{start} , 2 ) ]\end{matrix} \\ \{ {A}_{neighbour} \vert P ( [ {A}_{start} , {A}_{neighbour} ] ) > 0 \}\end{matrix} \qquad ( 3 )$$

In equation (3), the S and L are parameters of the algorithm and are fixed for the entire algorithm.

During the enforcement phase, a sequence of addresses may arrive at the monitoring and enforcement engine, A₁, A₂, . . . , A_{M}, and the system may verify the validity of the sequence of addresses. To verify the validity of the sequence, the addresses may be processed in chunks of size L. Once addresses are processed up to a particular address, Aₜ, then only addresses following will require verification, such as Aₜ, Aₜ₊₁, . . . , A_{M}. Accordingly, the system may compute L−1 hashes of subsequences that start with Aₜ by gradually increasing the size of the subsequence up to L, to produce a set of hashes of subsequences,

$$hash ( [ {A}_{t} , {A}_{t + 1} ] ) , hash ( [ {A}_{t} , {A}_{t + 1} , {A}_{t + 2} ] ) , \text{} … , hash ( [ {A}_{t} , {A}_{t + 1} , … , {A}_{t + L} ] ) .$$

Subsequently, by doing a lookup in the AddressStat for key Aₜ, a set of likely hashes based on the start address and various sequence lengths can be produced. Iterating a sequence length k from longest L to shortest 2, the system may then check if hash([Aₜ, Aₜ₊₁, . . . , Aₜ₊ₖ]) is present in array of likely hashes LikelyHash_{S}(Aₜ,k). If the system is able to identify such a hash, then the system may stop iterating. If such hash was found by the system, then it is possible to skip verification of all the nodes between Aₜ and Aₜ₊ₖ because the path that connects those was encountered during observation and is identified based on the hash value. Accordingly, the system may mark all addresses before Aₜ₊ₖ as processed and repeat the above algorithm with the remaining unprocessed transitions.

If, instead, such a hash was not found after all iterations, the system may check if the transition [Aₜ, Aₜ₊₁] exists using the information received from AddressStat. If Aₜ₊₁ is in the list {A_{neighbour}|P([Aₜ,A_{neighbour}])>0} then the transition is valid. The system may then mark Aₜ as processed and repeat the algorithm for addresses after Aₜ₊₁. If, instead, Aₜ₊₁ is not found in the list, then it is invalid and the system will report the transition as invalid, stop the transition, or perform other enforcement actions as described herein.

In some instances, the example described herein may use a single hash table lookup for each L transition. In some instances, the number of look ups may be equal to the number transitions.

The techniques and systems described herein may be embodied in software, hardware, or hybrid environments that use both software and hardware for observing and monitoring application processes. In the software embodiment, CPU technologies produce CPU telemetry that represents executions of a process in terms of CPU instructions. Telemetry feeds from different CPUs may be represented in a CFDG representation that allows any CPU technology, regardless of format, language, or specific embodiment, to provide instruction level monitoring at the CPU telemetry level across devices. This normalization to the CFDG enables analysis to be run on the CFDG independent of the CPU system generating the telemetry, meaning that the techniques and processes described herein may be rolled out and implemented with a wide variety of CPU technologies. Furthermore, in some examples, workloads may run on different levels of abstraction from hardware, such as on bare metal, virtual machines (VMs) or container ecosystems. The CFDG enables consistent analysis and monitoring of such varied operating environments.

For example, in the case of applications running on bare-metal systems, the correlation between a given application and the CPU(s) that it is executing on is directed by the operating system. This presents the simplest application-to-CPU telemetry mapping scenario. A more complex scenario is presented with virtual machines. In some examples, VM technologies have already included abstraction of the CPU monitoring capabilities natively into their hypervisor ecosystem. Whenever already supported, such CPU monitoring capabilities can be leveraged to provide application-to-CPU correlations in a normalized and consistent manner. In some examples, the CFDG representation at the abstraction layer for a particular CPU may be added for monitoring and enforcement. In some examples, CPU telemetry may not be readily available or exist. In such examples, the systems and methods herein may provide a virtualization layer that provides an equivalent of CPU telemetry or an abstraction of the application or workload.

In a hybrid environment, a combination of both software and hardware can be combined to provide the observability and monitoring functionality. In such examples, the CPU telemetry can be substantial, on the order of gigabits per second that may cause problems for scaling the monitoring capability. In some examples, the CPU telemetry may be directed to a sidecar hardware component to perform analysis. In this embodiment a hardware pipeline would be used to process the CPU telemetry and the analysis of the control flow is done on either an FPGA, GPU, ASIC, or other hardware device on the same system. In such examples, the telemetry is pipelined to these other hardware devices without interfering with the operation of the workload on the CPU. In this mode, only the violations (e.g., results of monitoring and enforcement that require action) are sent back to the CPU from the FPGA, GPU, or other hardware processing in the pipeline. In such examples, analysis and detection may be performed on hardware and only violations, or executions that trigger enforcement, would be sent back to the CPU for further action.

In a hardware environment, the CFDG is downloaded to the CPU. When the hardware determines that a violation has occurred, then the instruction sequence can be captured as telemetry (e.g., the sequence of instructions that led to the violation and the violating instruction itself). Some predetermined number of preceding instructions can be configured to be captured. Such an implementation may reduce the set of CPU telemetry around the specific violations.

Given an observed CFDG for the process being monitored, the systems and methods described herein are able to detect the most advanced code-reuse attacks by observing new invalid transfers of the instruction pointer to attacker-selected code gadgets. Very often these attacks are very hard to detect by just doing, for example, system-calls monitoring because any modern application has very large profile of calls that it normally does, so attacker code can do a lot of damage and still easy maintain a completely valid system-call profile.

An aspect of this disclosure is about leveraging a sequence of CPU control flow transitions, which could be represented as the CFDG, a machine learning model or any number of other potential embodiments. After the CFDG is observed as described above, then the systems and techniques may monitor and enforce executions at the CPU according to the observed CFDG.

In some examples, since the CPU telemetry is collected in batches, a number of CPU instructions might have already executed at the time enforcement is taken. Effectively, enforcement might be delayed a few milliseconds relative to when the actual violating instruction took place. This still enables the systems and techniques to prevent the attacker exploit, which typically is many CPU instructions after the initial vulnerability (e.g., a buffer overflow) and first invalid transition has been made use of.

A number of software-based enforcements can be taken, and these will depend on the application environment. For example, if the application is running on a bare-metal system, and thus separated from the hardware it is running on by a single layer of abstraction only (i.e., the operating system), then a first option would be to simply kill the process.

If, on the other hand, the application is running within a virtual machine, then the virtual machine could be terminated via VM infrastructure management APIs (supported by VMWare, KVM, and other similar vendors). Similarly, if the application was running within a container, a termination command could be issued to via the container management API.

In addition to these all-or-nothing policy-enforcement options, there are also a number of other possibilities to prevent continuing execution of the binary.

One such example policy-enforcement option would be the use of function hooking mechanisms to block specific function calls from executing. Additionally, system calls can be intercepted by using eBPF hook methods. Using this approach, a subset of functions may be allowed to continue to operate, while others are blocked because they could impact the integrity of the system. For example, a thread-priority system-call might be allowed to continue to execute after a violation is observed, whereas a write operation might be blocked to prevent a critical file from being overwritten.

Another example might be to block certain function calls based on the execution context or the permissions the binary is operating with. For example, a system process might have a greater number of potential function calls blocked when a violation is observed, whilst a low privileged process might be allowed to make a broader set of function calls when a violation is detected because it presents a lower risk.

A third example may include letting an application continue to execute but to block all communications from the application from executing. This could include both remote and local communications, which may include sockets, files, RPC protocols, memory mapped I/O, etc. In such a scenario, an application that has violated the guardrails might be allowed to continue to run, but not be able to interact with any other application or system. Such guarded execution may be helpful to forensically analyze the intent of the attack, without actually enabling it to cause harm.

System calls could be classified based on their behaviors and given a risk score associated with that system call. Some system calls will be impacted by the data that is passed to the call and therefore the risk score of that system call may be weighted by the data passed to the call as a factor in the overall score. Using this technique, the decision as to what system calls can be made after a violation can be based on the risk scoring. Since OS APIs are well documented it would be relatively straightforward to build a catalog of system calls across various OSes and then build a risk scoring mechanism that accounts for the API, OS and data passed.

Another example may include intercepting key system calls and at the start of the call solution would decode CPU telemetry, say one hundred or some other predetermined number of transitions before the intercepted system call and validate them according to the observed CFDG for the process. If all transitions leading to system call are valid according to the observed CFDG then the given call would be allowed, otherwise the call would be denied.

In a hybrid environment, a combination of both Software and Hardware can be combined to provide the enforcement. In an example, a hardware pipeline may be used to process the CPU telemetry and the analysis of the control flow is done on either an FPGA, GPU, ASIC, or other hardware device on the same system. The telemetry is pipelined to these other hardware devices without interfering with the operation of the workload on the CPU. In this mode, only the violations are sent to the CPU from the FPGA, GPU, or other hardware processing in the pipeline. Using this approach, the analysis and detection is done in hardware, while the enforcement (e.g., killing a process that violates the observed CFDG) is done in software similar to what is described in the software examples above. In some examples, a CPU halting mechanism may be used by the side-car hardware system (e.g., GPU or FPGA) using a bus or a UEFI system function such as C1/C1E or HALT-State. Other techniques could be invoked from hardware directly such as a Break-3 to target a specific process via the debugging function previously described.

Because the CPU telemetry is collected in batches, a number of CPU instructions might have already executed at the time enforcement is taken. Effectively, enforcement might be delayed a few milliseconds relative to when the actual violating instruction took place. As previously noted, this is deemed acceptable since the goal of the solution is to prevent the attacker exploit, which typically is many CPU instructions after the initial vulnerability (e.g., a buffer overflow) has been made use of In some examples, as part of the process, the processor trace may be stopped in response to the system call and the transitions leading to the system call will be in the buffer but will be flushed upon stopping. After stopping, every transition leading to the system call can be examined, including those that were previously in the buffer.

In some examples, the systems and methods could also allow the sidecar hardware to send the violation event to some other hardware component outside of the CPU to perform the CPU-freeze operation if desired. This might be accomplished via UEFI interface, for example. In such a model, the security aspect of the solution is stronger, because the freezing is done from entirely outside of the OS/CPU ecosystem if desired.

In a hardware implementation, the observed CFDG computed for the workload is downloaded to the CPU hardware. The CPU is then capable of enforcing the code execution directly in hardware at the time of instruction execution. In this embodiment, the generation of telemetry is entirely optional, or during the observation phase only. When the hardware determines that a violation has occurred, the faulting instruction can be halted, and a new interrupt type can be used to indicate the instruction-halting. This new interrupt can be serviced by the OS to kill execution of the process. The CPU can optionally freeze all operations until the interrupt is serviced by OS. This new halting instruction is slightly different than the existing halt instruction, in that it is intended to halt operation of the offending process while allowing the CPU to service other processes scheduled by the kernel. The OS is expected to eject the offending process from continuing execution on the CPU. This could be by suspending all threads of execution, the offending thread of execution or termination of the process entirely, based on some policy.

Additionally, a telemetry event can be generated as to the halt, with or without a corresponding halt interrupt. There are three telemetry settings that may be used in some examples. (1) Full Telemetry, that is equivalent to existing telemetry feature offered on modern CPUs today. (2) Halting Telemetry wherein only telemetry associated with the halting event is generated. This can include a subset of CFDG sequences leading up to the violation that resulted in the halt (e.g., a small amount of historical control flow sequences leading up to and including the halting event). (3) No telemetry wherein there is no telemetry provided as to the halting event during enforcement mode. Regular telemetry is provided when observing the CFDG. The halting is performed on the process or workload, however no meta data is exchanged over the telemetry bus.

The transitions of CFDG can be stored in a Bloom Filter or a Bloom Filter Trie (BFT) or other fast search data structure for efficiency. While the whole CFDG could be stored in the CPU cache (or in generic memory accessible by the CPU), an enhancement is to store only a subgraph of the entire graph using a sliding window algorithm. This subgraph of the CFDG includes all the directly reachable nodes from the current instruction, plus N-depth child nodes set by configuration. As the CPU instructions traverse the nodes of the embedded subgraph, a refresh of the CPU-cached subgraph, from the full memory mapped graph, is done to include newly reachable nodes (and child nodes) from the original CFDG. This represents the sliding window approach described above. Restated, as the CPU executes instructions, it looks to see if enough node-depth remains in the subgraph and if it reaches some threshold (e.g., must-be-two-nodes deep), it automatically updates its cache with a new subgraph from the original CFDG to meet those constraints.

In some examples, enforcement of the observed CFDG may be accomplished by analyzing when for every given source address, the CPU is provided with quick Content Addressable Memory (CAM) table which will provide entry for every valid destination. If no entry is found in such table, CPU knows that attempted transfer is not valid and generate halt instruction informing software with all the contextual information.

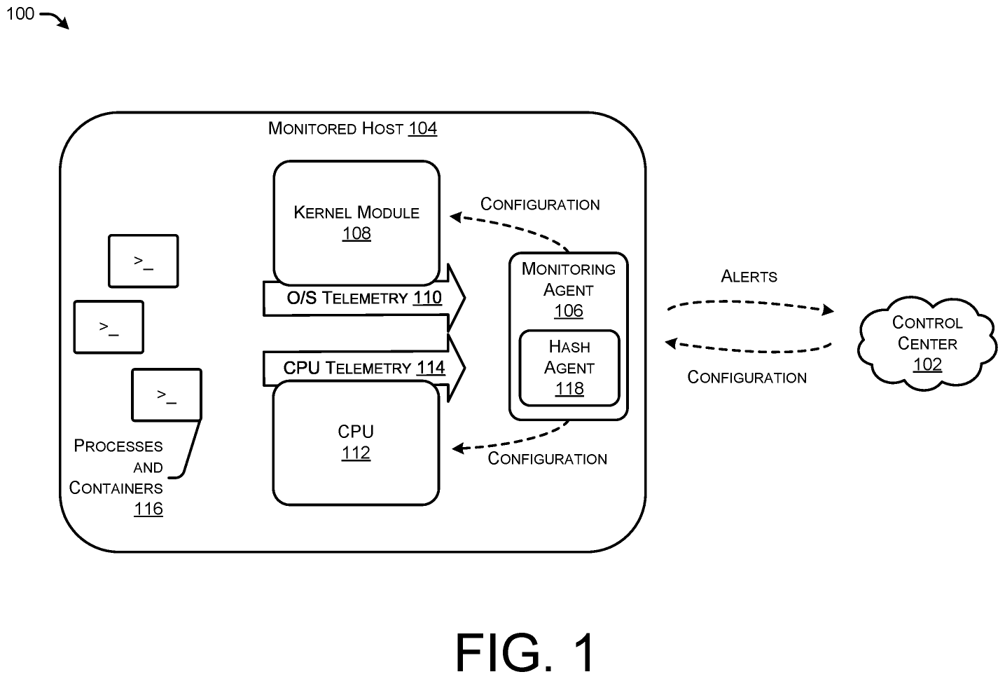

Turning now to the figures, FIG. 1 illustrates an example system architecture for control flow monitoring using an observed control flow graph, according to at least one example. The monitoring system 100 provides for extremely secure (detecting most advance code reuse attacks) workload execution monitoring in real-time allowing for the enforcement of the intended operations of the workloads to be done in a highly secure manner.

The monitored host 104 may include a computing device and may include a local device as well as various virtual workloads such as bare metal machines, virtual machines, and containers. The monitored host 104 includes a CPU 112 that produces CPU telemetry 114 as the CPU executes the processes and containers 116. Additionally, the monitored host 104 includes a kernel module 108 that may provide operating system telemetry (O/S telemetry 110) as the processes and containers 116 are executed. A monitoring agent 106 of the monitored host 104 receives the O/S telemetry 110 and the CPU telemetry 114 for monitoring the executions of the processes and containers 116.

Using the CPU telemetry 114, the monitoring agent 106, which is in communication with a control center 102, monitors execution of any process of interest, whether these processes are running on bare metal, within virtual machines, or inside of containers.

In an example, the monitoring agent 106 uses a hardware-assisted technology to apply an observed CFDG to monitor the monitored host 104. The monitoring agent 106 initially observes the CFDG in an observation phase and then monitors or enforces, during an enforcement phase, executions according to the observed CFDG. In some examples these two phases can be done together. In the observation phase, the processes, and containers 116 are executed as normal, such as during a trial phase or initial setup phase. The observation phase may include observing executions based on the CPU telemetry 114 and/or the O/S telemetry 110 and building the CFDG based on observed executions. In this manner, the CFDG is an observed CFDG built based on observed executions by the application occurring at the CPU 112 and/or the kernel.

The monitoring agent 106 may include a hash agent 116 that is used to increase a speed of processing the telemetry received at the monitoring agent 106. For example, the control flow graph may include paths that are frequently traversed (e.g., major paths such as function calls) and paths that are less frequently traversed (e.g., loops and conditional branches). Within the frequently traversed paths, including major branches and paths, most applications, and processes will traverse a similar or repeated path frequently, meaning the application will follow one or more sequences of executions in the exact same order a large number of times. The monitoring agent 106 engine may use this repetitive sequence of executions to filter functions out and speed up the monitoring of executions by identifying such frequently traversed sequences based on information stored at and/or in association with the hash agent 118.

The hash agent 118 may include a hardware filtering function that uses a rolling hash of the major functions. Since the applications will traverse one or more paths repeatedly, this hash agent 118 may filter out valid transitions by comparing the hash value against a learned or observed hash value during the observation phase associated with the one or more paths without having to compare each transition within the sequence. In the event that the hash of the currently observed transition doesn't match the learned and/or stored hash value then the hash agent 118 and/or monitoring agent 106 will inspect the individual branches taken during the sequence against the observed CFDG and may determine that the execution is progressing still within the bounds of the learned CFDG.

After the observation period, a typical application execution will most likely follow one or more of the same major paths. In some examples, the hash agent 118 may be used to calculate a rolling hash token for these major path transitions. This may compress a sequence of transitions into a smaller group for processing rather than processing an entire set of sequences. During the observation phase, and/or during the enforcement phase, the hash agent 118 may build a table of hash values for such major paths. Subsequently, a filter running in either hardware or software of the hash agent 118 may verify or compare the hash values from the rolling hash against the table to speed up the monitoring of executions. This improvement enhances the performance of the monitoring agent 106 by capitalizing on the fact that under normal circumstances applications will be traversing a small number of repeated and valid subgraphs.

The transition from observation phase to monitoring and/or enforcement of the observed CFDG. The switch between the observation phase and the enforcement phase may be automatic and may be based on one or more different approaches. In some examples, one or more of the approaches described herein may be used to trigger or cause the transition from observation to enforcement. In some examples, one or more of the following approaches may be combined and/or used interchangeably based on desired optimizations for confidence, time, compute-cycles, etc. or combinations thereof. In some examples, the transition may be bidirectional, with particular triggers to transition from observation to enforcement (e.g., observed code percentage, confidence, policy conditions, etc.) and separate triggers to transition from enforcement back to observation (e.g., new code, patched code, tickets opened for errors or problems, etc.).

In some examples, the system may transition from observing executions and thereby observing the CFDG to enforcement based on a confidence score. The confidence score may reflect a percentage of the underlying code and/or transitions that have been observed. For instance, in an example, the confidence score may directly correlate to the percent of observed code executions as a ratio of total control flow transitions. In an illustrative example, the system may begin observations at a confidence score of 0 (reflecting the initial state where all control flow transitions are unknown). Then as the system begins to observe control flow transitions the confidence of the observations may proportionally increase.

Based on the confidence score, the system may be configured to automatically transition to enforcement once a threshold confidence score is reached. For instance, an operator (e.g., a security officer for an organization) may be presented with GUI option to explicitly set the transition point from observation to enforcement. For example, an operator may choose to have the system automatically move from observation mode to enforcement mode when the confidence score is 99.999% (or some other score). Similarly, a progress indicator graph could be presented to the operator that would show a representation of the current confidence score and an estimated time of when the system would transition to the enforcement phase based on the rate of observation and the proportion of unobserved transitions remaining within the code. Upon reaching the set confidence score, the system may transition to enforcement. In the event that there is a subsequent patch or change in code coverage, for example with modified code, the system may determine to re-renter the observing or observation mode until the confidence score is reached once again for the modified code.

In some examples, after some predetermined period of time (e.g., seconds, minutes, days, weeks, etc.) and/or based on coverage on an amount of the code of the processes and containers 116 (e.g., when the observed code used to build the observed CFDG reaches a threshold such as 50%, 60%, 701%, 80%, 90%, etc.), then the observation phase may automatically be completed. In some examples, the observation phase may be monitored by a security team who may determine when to exit the observation phase and enter a monitoring phase.

Using the CPU telemetry 114 and/or the O/S telemetry 110, the monitoring agent 106 and/or hash agent 118 monitors execution of the processes and containers 116, whether these processes are running on bare metal, within virtual machines, or inside of containers. Given an observed CFDG for the process being monitored, the monitoring agent 106 is able to detect the most advanced code-reuse attacks by observing invalid transfers of the instruction pointer to attacker-selected code gadgets. The monitoring agent 106 can leverage the CPU telemetry 114 and/or the O/S telemetry 110 to monitor executions using the observed CFDG, a machine learning model, or any number of other potential embodiments.

In the monitoring phase, the CPU telemetry 114 and/or the O/S telemetry 110 may be compared, by the monitoring agent 106 against the observed CFDG to identify deviations from the observed CFDG and thereby identify potential code reuse attacks or other potential exploits before they can be executed. In some examples, only observed transitions during the observation period will be allowed to execute, and others may be treated as invalid transfers and either cause a default action (e.g., cancel the execution), remedial action, or identify further information (e.g., the sequence that led to the invalid request to determine if the request should be valid based on a valid sequence leading to the request). The monitoring may be locally performed, performed using a cloud-based system using a monitoring agent at the local device, monitored on a network, or otherwise implemented.

In some examples, the control center 102 may receive alerts from the monitoring agent 106 indicative of deviations from the observed CFDG. The control center 102 may provide additional functionality, such as to enable a security operations center (SOC) to appropriately respond, including reporting of the exploit and/or directing the monitored host 104 how to respond, whether to kill the process, redirect, shut down the monitored host 104, or other such actions.

Given an observed CFDG for the process being monitored, the monitoring agent 106 may be embodied in software, hardware, or hybrid environments that use both software and hardware for observing and monitoring application processes. In the software embodiment, the CPU 112 produces the CPU telemetry 114 that represents executions of a process in terms of CPU instructions. The CPU telemetry 114 and/or the O/S telemetry 110 from the kernel module 108 as well as other telemetry feeds from different CPUs may be directed to the monitoring agent 106. The telemetry may be represented in a CFDG representation that allows any CPU 112, regardless of format, language, or specific embodiment, to provide instruction level monitoring at the CPU telemetry 114 level across devices. This normalization to the CFDG enables analysis to be run on the CFDG independent of the CPU 112 generating the CPU telemetry 114, meaning that the techniques and processes described herein may be rolled out and implemented with a wide variety of CPU technologies. Furthermore, in some examples, workloads may run on different levels of abstraction from hardware, such as on bare metal, virtual machines (VMs) or container ecosystems. The CFDG enables consistent analysis and monitoring of such varied operating environments.

For example, in the case of applications running on bare-metal systems, the correlation between a given application and the CPU 112 that it is executing on is directed by the O/S. The correlation between the application and the CPU 112 is enabled by the correlation between the O/S telemetry 110 and the CPU telemetry 114. This correlation may provide a mapping between the telemetry and may result in the use of the kernel module 108. This presents the simplest application-to-CPU telemetry mapping scenario. A more complex scenario is presented with virtual machines. In some examples, VM technologies have already included abstraction of the CPU telemetry capabilities natively into their hypervisor ecosystem. Whenever already supported, such CPU monitoring capabilities can be leveraged to provide application-to-CPU correlations in a normalized and consistent manner. In some examples, the CFDG representation at the abstraction layer for a CPU 112 may be added for monitoring and enforcement. In some examples, CPU telemetry 114 may not be readily available or exist. In such examples, the systems and methods herein may provide a virtualization layer that provides an equivalent of CPU telemetry 114 or an abstraction of the application or workload.

In a hybrid environment, a combination of both software and hardware can be combined to provide the observability and monitoring functionality. In such examples, the CPU telemetry 114 can be substantial, on the order of gigabits per second that may cause problems for scaling the monitoring capability. In some examples, the CPU telemetry 114 may be directed to a sidecar hardware component (such as a hardware component that may be part of the monitoring agent 106) to perform analysis. In this embodiment a hardware pipeline would be used to process the CPU telemetry 114 and the analysis of the control flow is done on either an FPGA, GPU, ASIC, or other hardware device on the same system. In such examples, the CPU telemetry 114 is pipelined to these other hardware devices without interfering with the operation of the workload on the CPU 112. In this mode, only the violations (e.g., results of monitoring and enforcement that require action) are sent back to the monitoring agent 106 from the FPGA, GPU, or other hardware processing in the pipeline. In such examples, analysis and detection may be performed on hardware and only violations, or executions that trigger enforcement, would be sent back to the CPU 112 for further action.

In a hardware environment, the CFDG is downloaded to the CPU 112. When the hardware determines that a violation has occurred, then the instruction sequence can be captured as CPU telemetry 114 (e.g., the sequence of instructions that led to the violation and the violating instruction itself). Some predetermined number of preceding instructions can be configured to be captured by the monitoring agent 106 and reported to the control center 102. Such an implementation may reduce the set of CPU telemetry around the specific violations.

Given an observed CFDG for the processes and containers 116, the monitoring agent 106 may capture the CPU telemetry 114 in batches, such that a number of CPU instructions might have already executed at the time enforcement is taken. Effectively, enforcement might be delayed a few milliseconds relative to when the actual violating instruction took place. This still enables the monitoring agent 106 to prevent the attacker exploit, which typically is many CPU instructions after the initial vulnerability (e.g., a buffer overflow) and first invalid transition has been made use of.

A number of software-based enforcements can be taken by the monitoring agent 106, and these will depend on the application environment. For example, if the application is running on a bare-metal system, and thus separated from the hardware it is running on by a single layer of abstraction only (i.e., the operating system), then a first option would be to simply kill the process.

If, on the other hand, the application is running within a virtual machine, then the virtual machine could be terminated via VM infrastructure management APIs (supported by VMWare, KVM, and other similar vendors). Similarly, if the application was running within a container, a termination command could be issued to via the container management API

In addition to these all-or-nothing policy-enforcement options, there are also a number of other possibilities to prevent continuing execution of the binary. One such example policy-enforcement option would be the use of function hooking mechanisms to block specific function calls from executing. Additionally, system calls can be intercepted by using eBPF hook methods. Using this approach, a subset of functions may be allowed to continue to operate, while others are blocked because they could impact the integrity of the system. For example, a set/get thread-priority system-call might be allowed to continue to execute after a violation is observed, whereas a write operation might be blocked to prevent a critical file from being overwritten.

Another example might be to block certain function calls based on the execution context or the permissions the binary is operating with. For example, a system process might have a greater number of potential function calls blocked when a violation is observed, whilst a low privileged process might be allowed to make a broader set of function calls when a violation is detected because it presents a lower risk.

A third example may include letting an application continue to execute but to block all communications from the application from executing. This could include both remote and local communications, which may include sockets, files, RPC protocols, memory mapped I/O, etc. In such a scenario, an application that has violated the guardrails might be allowed to continue to run, but not be able to interact with any other application or system. Such guarded execution may be helpful to forensically analyze the intent of the attack, without actually enabling it to cause harm.

In some examples, system calls could be classified based on their behaviors and given a risk score associated with that system call. Some system calls will be impacted by the data that is passed to the call and therefore the risk score of that system call may be weighted by the data passed to the call as a factor in the overall score. Using this technique, the decision as to what system calls can be made after a violation can be based on the risk scoring. Since OS APIs are well documented it would be relatively straightforward to build a catalog of system calls across various OSes and then build a risk scoring mechanism that accounts for the API, OS and data passed.

Another example may include intercepting key system calls and at the start of the call solution would decode the CPU telemetry 114, a predetermined number of transitions before the intercepted system and validate them according to the observed CFDG for the process. If all transitions leading to system call are valid according to the observed CFDG then the given call would be allowed, otherwise the call would be denied.

In a hybrid environment, a combination of both software and hardware can be combined to provide the enforcement through the monitoring agent 106. In an example, a hardware pipeline may be used to process the CPU telemetry 114 and the analysis of the control flow is done on either an FPGA, GPU, ASIC, or other hardware device on the same system. The telemetry is pipelined to these other hardware devices without interfering with the operation of the workload on the CPU 112. In this mode, only the violations are sent to the monitoring agent 106 from the FPGA, GPU, or other hardware processing in the pipeline. Using this approach, the analysis and detection is done in hardware for performance and added security, while the enforcement (e.g., killing a process that violates the observed CFDG) is done in software similar to what is described in the software examples above. In some examples, a CPU halting mechanism may be used by the side-car hardware system (e.g., GPU or FPGA) using a bus or a UEFI system function such as C1/C1E or HALT-State. Other techniques could be invoked from hardware directly such as a Break-3 to target a specific process via the debugging function previously described.

In some examples, the monitoring agent 106 could also allow the sidecar hardware to send the violation event to some other hardware component outside of the CPU 112 to perform the CPU-freeze operation if desired. This might be accomplished via UEFI interface, for example. In such a model, the security aspect of the solution is stronger, because the freezing is done from entirely outside of the OS/CPU ecosystem if desired.

In a hardware implementation, the observed CFDG computed for the workload is downloaded to the CPU 112. The CPU 112 is then capable of enforcing the code execution directly in hardware at the time of instruction execution. In this embodiment, the generation of telemetry is entirely optional. When the hardware determines that a violation has occurred, the faulting instruction can be halted, and a new interrupt type can be used to indicate the instruction-halting. This new interrupt can be serviced by the OS to kill execution of the process. The CPU 112 can optionally freeze all operations until the interrupt is serviced by OS. This new halting instruction is slightly different than the existing halt instruction, in that it is intended to halt operation of the offending process while allowing the CPU 112 to service other processes scheduled by the kernel. The OS is expected to eject the offending process from continuing execution on the CPU 112. This could be by suspending all threads of execution, the offending thread of execution or termination of the process entirely, based on some policy.

Additionally, a telemetry event can be generated as to the halt, with or without a corresponding halt interrupt. There are three telemetry settings that may be used in some examples. (1) Full Telemetry, that is equivalent to existing telemetry feature offered on modem CPUs today. (2) Halting Telemetry wherein only telemetry associated with the halting event is generated. This can include a subset of CFDG sequences leading up to the violation that resulted in the halt (e.g., a small amount of historical control flow sequences leading up to and including the halting event). (3) No telemetry wherein there is no telemetry provided as to the halting event during enforcement mode. Regular telemetry is provided when observing the CFDG. The halting is performed on the process or workload, however no meta data is exchanged over the telemetry bus.

The CFDG can be stored in a Bloom Filter or a Bloom Filter Trie (BFT) for efficiency. While the whole CFDG could be stored in the CPU cache (or in generic memory accessible by the CPU), an enhancement is to store only a subgraph of the entire graph using a sliding window algorithm. This subgraph of the CFDG includes all the directly reachable nodes from the current instruction, plus N-depth child nodes set by configuration. As the CPU instructions traverse the nodes of the embedded subgraph, a refresh of the CPU-cached subgraph, from the full memory mapped graph, is done to include newly reachable nodes (and child nodes) from the original CFDG. This represents the sliding window approach described above. Restated, as the CPU 12 executes instructions, it looks to see if enough node-depth remains in the subgraph and if it reaches some threshold (e.g., must-be-two-nodes deep), it automatically updates its cache with a new subgraph from the original CFDG to meet those constraints.

In some examples, enforcement of the observed CFDG may be accomplished by analyzing when for every given source address the CPU 112 is provided with quick CAM table which will provide entry for every valid destination. If no entry is found in such table, the CPU 112 knows that attempted transfer is not valid and generate halt instruction informing software with all the contextual information.

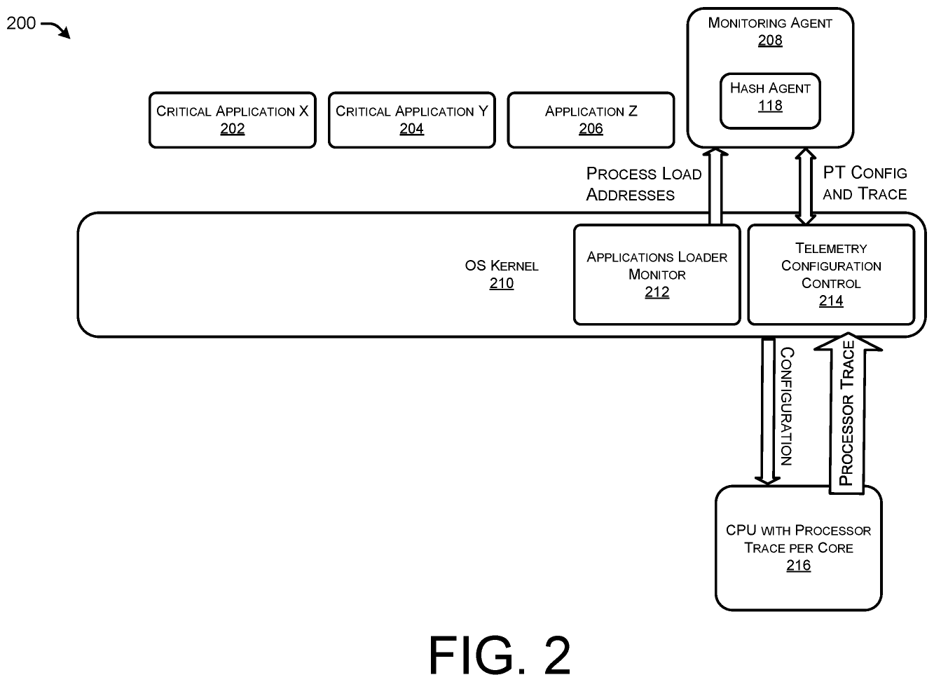

FIG. 2 illustrates an example control flow monitor architecture 200, according to at least one example. The control flow monitor architecture 200 includes a critical application X 202, a critical application Y 204, an application Z 206, and a control flow observing and monitoring engine. The monitoring agent 208, which may be the same or similar to the monitoring agent 106 of FIG. 1, may be used to observe applications and executions and build a CFDG and subsequently monitor the applications and the executions by the CPU 216 and/or the OS kernel 210. The monitoring agent 208 may determine to transition from observation (e.g., building the CFDG) to monitoring (e.g., enforcement of the CFDG) as described above and may subsequently receive processor trace configuration, telemetry, and trace information from the telemetry configuration control module 214 of the OS kernel 210 based on processor trace of the CPU 216. The monitoring agent 208 additionally receives process load addresses from an application loader monitor 212 of the OS kernel 210. The monitoring agent 208 may implement a hash agent 118, as described above, to process one or more transitions in a sequence simultaneously using a rolling hash without requiring processing of each individual transition in the sequence.

In operation, the monitoring agent 208 provides real time observing and monitoring of the control flow diagram graph for running processes, including those associated with the critical application X 202, critical application Y 204, and critical application Z 206. The monitoring agent 208 may detect one or more invalid transitions based on the observed CFDG as described herein. With the control flow monitor architecture 200, no pre-processing is required or binary modifications before the monitoring can take place, thereby enabling the real time monitoring.

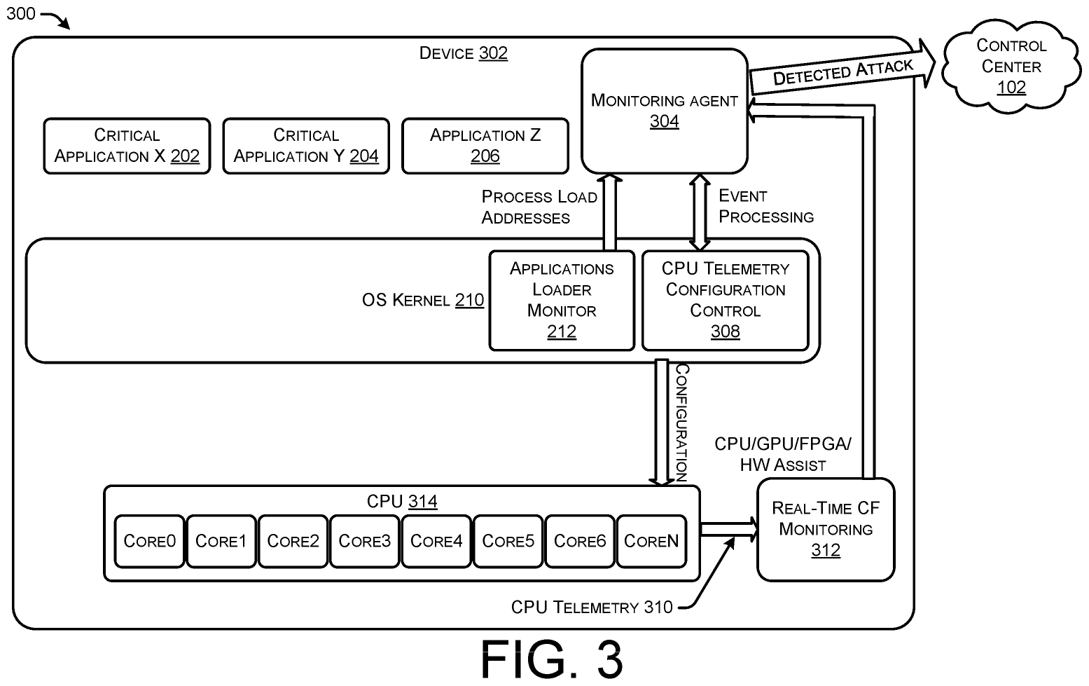

FIG. 3 illustrates an example system architecture 300 for a software and hardware system to observe and monitor application executions, according to at least one example. In the example system architecture 300, the CFDG computed for a workload is downloaded to the device 302 that is being monitored. When the monitoring agent 304 (which may include a hash agent as described above (determines that a violation has occurred based on telemetry from the CPU 314 and the telemetry configuration control 308 (which may similar and/or identical to the telemetry configuration control 214 of FIG. 2), the faulting instruction sequence can be captured as telemetry (e.g., what instruction sequence led to the violation and the violating instruction itself). This could be driven by policy where the number of preceding instructions can be configurable. Since this is only monitoring for violations, some number of subsequent calls, post violation, can also be sent (based on policy). This results in a greatly reduced set of CPU telemetry focused only around the violations. In this system, the reduced telemetry set can be sent to an on-prem or cloud analytics platform for further evaluation and action.

The CFDG can be optimized using a sliding window approach to load the intended instruction sequences in a smaller set to improve optimization of the use of the CPU cache.

In some examples, the CPU telemetry 310 may be provided from the CPU 314 to a GPU 312 and/or a FPGA/ASIC for real-time monitoring of the control flow graph. The GPU 312 may communicate the real-time monitoring with the monitoring agent 304. The GPU 312 may communicate directly with the monitoring agent 304 or via the CPU telemetry configuration control 308. Because the instruction-pointer level data of the CPU telemetry 310 can be substantial, the GPU may be used as a hardware pipeline to process the CPU telemetry 310 and provide analysis of the CFDG. In this manner, the CPU telemetry 310 is pipelined to these other hardware devices without interfering with the operation of the workload on the CPU. In this mode, only the violations are sent back to the monitoring agent 304 from the GPU 312. The pipeline might use a private bus if that is available. Using this approach, the analysis and detection is done in hardware and/or a hardware assisted device such as the GPU 312 and only the violations are sent back to the CPU 314 for further treatment. Alternatively, the sidecar hardware could send the violation events to the control center 102 directly.

In some examples, CFDG may be leveraged to identify and prevent execution of vulnerable code sections and/or malicious code sections. There are two phases to the process, observation, and policy enforcement. In some scenarios these two phases can be done together. There are several monitoring embodiments possible by the monitoring agent 304, including (1) a software embodiment; (2) a hybrid embodiment; and (3) a hardware embodiment.

In the software embodiment example, the CPU 314 can produce CPU telemetry 310 that represents the execution of a process in terms of CPU instructions. The telemetry from disparate types of CPUs may be represented in a common format that represents the execution flow of an application or workload, the CFDG. In this example, we normalize the CPU instructions into a common Control Flow Directed Graph representation that allows any CPU technology, that offers instruction-level monitoring capabilities, to be represented in a common format. This normalization allows for analysis to be run on the control flow independent of the CPU system that is generating the telemetry.

Additionally, there are scenarios where workloads run on different levels of abstraction from the hardware—Bare metal, VMs or container ecosystems. In order to provide for a consistent outcome, the correlations between CPU instruction telemetry and the application needs to be normalized, despite additional layers abstraction that may be present, such as hypervisors or container orchestrators.

In the case of applications running on bare-metal systems, the correlation between a given application and the CPU(s) that it is executing on is directed by the operating system. This presents the simplest application-to-CPU telemetry mapping scenario. A more complex scenario is presented with virtual machines.

In some cases, VM technologies have already included the abstraction of the CPU monitoring capabilities natively into their hypervisor ecosystem, while in other cases they have not done so. As such, wherever already supported, these CPU monitoring capabilities can be leveraged and expanded to provide the application-to-CPU correlations in a normalized manner, so that these may be consumed in a single format. For example, the techniques may include selecting one of the vendor formats and provide a conversion mechanism to make other CPU telemetry ecosystems match that raw format. Alternatively, the techniques may include simply adding the final CFDG representation at the abstraction layer for a CPU ecosystem that is not already supported for hypervisors or other virtualized ecosystems.

Finally, in some cases, where direct access to the CPU telemetry is not possible, another means of correlation of the application to the CPU telemetry is required. In such a scenario, we will either provide a thin virtualization layer that provides the equivalent CPU instruction-level telemetry or an abstraction directly underneath the application or workload. When this added abstraction layer is needed, the system will additionally normalize the data representation independent of the physical CPU used to execute the application or workload via the CFDG method.

In a hybrid environment, a combination of both Software and Hardware can be combined to provide the observability and monitoring functionality. The CPU telemetry 310, particularly at the instruction-pointer level, can be substantial. Often the amount of data produced by the CPU telemetry engine is gigabits per second. This makes it hard to build a practical solution that is highly scalable. One improvement that can be made is to feed the CPU telemetry to a sidecar hardware component to perform the analysis. In this embodiment a hardware pipeline would be used to process the CPU telemetry and the analysis of the control flow is done on either an FPGA, GPU, ASIC, or other hardware device on the same system. The CPU telemetry 310 is pipelined to these other hardware devices without interfering with the operation of the workload on the CPU. In this mode, only the violations are sent back to the CPU from the FPGA, GPU, or other hardware processing in the pipeline. The pipeline might use a private bus if that is available or use an existing bus if there is no means to do this via a dedicated private mechanism. Using this approach, the analysis and detection is done in hardware and only the violations are sent back to the CPU for further treatment (such as sending to an on-premises or cloud analytics system). Alternatively, the sidecar hardware could send the violation events to the cloud analytics directly, providing for better performance and improved security.

In a hardware embodiment, the CFDG computed for the workload is downloaded to the CPU hardware. When the hardware determines that a violation has occurred, the faulting instruction sequence can be captured as telemetry (e.g., what instruction sequence led to the violation and the violating instruction itself). This could be driven by policy where the number of preceding instructions can be configurable. Since this is only monitoring for violations, some number of subsequent calls, post violation, can also be sent (based on policy). This results in a greatly reduced set of CPU telemetry focused only around the violations. In this system, the reduced telemetry set can be sent to an on-premises or cloud analytics platform for further evaluation and action.

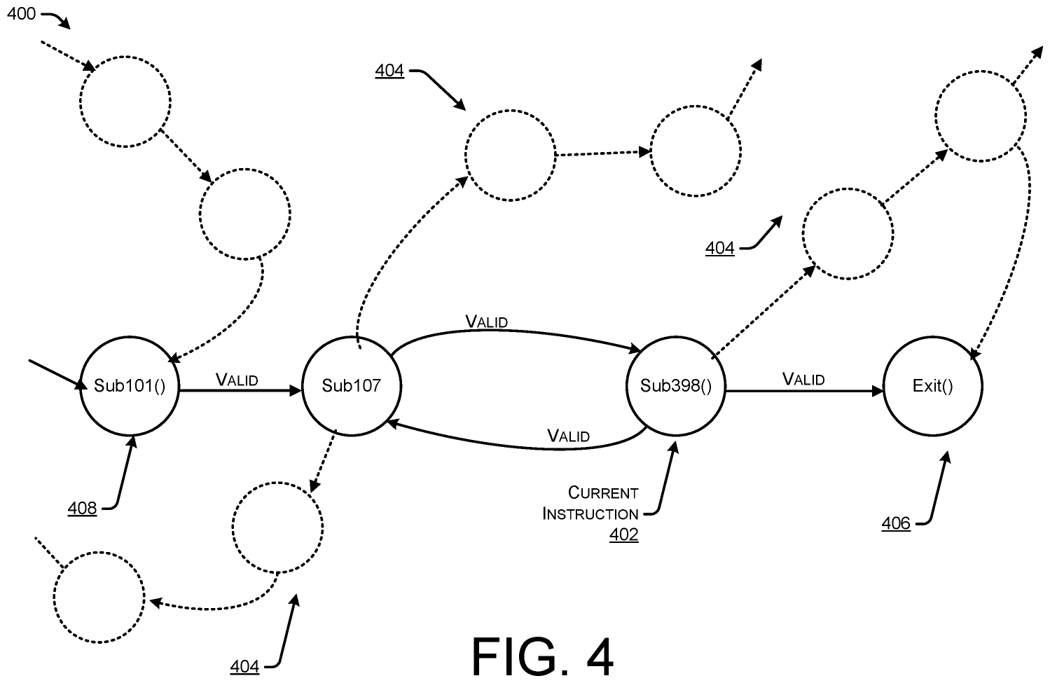

FIG. 4 illustrates an example of a control flow graph 400 used for monitoring application executions, according to at least one example. The control flow graph 400 is a representation, using graph notation, of control flow, i.e., execution, paths that may be traversed through an application during execution of the application. In the control flow graph 400, each node in the graph corresponds to a basic block. A basic block is a sequence of instructions where control enters only at the beginning of the sequence and control may leave only at the end of the sequence. In some examples, multiple transfers may begin from the same starting point. There is no branching in or out in the middle of a basic block. For example, a destination address, may correspond to a start of a basic block and an indirect branch instruction may correspond to an end of the block. An address of the indirect branch instruction may correspond to a source address. In some examples, binary analysis may be used to identify the address, therefore a previous address from an observed transition may be stored and become the source for the transition. A target address of the indirect branch instruction may correspond to a next possible address of a next basic block in the control flow graph 400, i.e., may correspond to a beginning address of a next/reachable basic block in the control flow graph 400. Edges between two basic blocks (e.g., a first block and a second block) represent control flow transfer to the beginning of the second block. A node may thus include a start address of the basic block, and a next possible start address of a next basic block i.e., a beginning address of a next/reachable basic block. The node may have a list of valid transitions, edges of the graph defining addresses where the flow may proceed, therefore each node has its own address and a list of destinations to which a valid transfer may be completed. The control flow graph 400 may be generated by, for example, source code analysis, binary analysis, static binary analysis, execution profiling, etc. The control flow graph may then include a plurality of legitimate execution paths. Each legitimate execution path may include a plurality of nodes connected by one or more edges.

The control flow graph 400 may be an example of the CFDG that is observed and use for enforcement as described herein. In some examples, the control flow graph 400 may be stored in a Bloom Filter, hash table, binary tree, or other fast access data structure. In some examples, non-graph structures may store address pairs of origins and destinations such that the data structure may be queried to determine validity of any transition. In some examples, the whole control flow graph 400 may be stored in the CPU cache or in memory accessible by the CPU. In some examples, only a subset of the control flow graph 400 may be stored using a sliding window algorithm. Accordingly, the subset of the control flow graph 400 includes all the directly reachable nodes from the current instruction at node 402, plus a predetermine number of child nodes that may be configured according to preferences. As the CPU instructions move through the control flow graph 400, for example from node 408 to node 402, a refresh of the subset may be determined based on the full control flow graph 400 to include newly reachable nodes and child nodes. The control flow graph 400 may include indications of nodes that the CPU instructions processed, as well as accessible branches 404 that were not processed but are available (child nodes). As the CPU executes instructions, for example from node 402 to 406, the CPU looks to see if enough node-depth remains in the subset of the control flow graph 400 and if it reaches some threshold (e.g., must-be-two-nodes deep), it automatically updates its cache with a new subgraph from the original control flow graph 400 to meet those constraints.

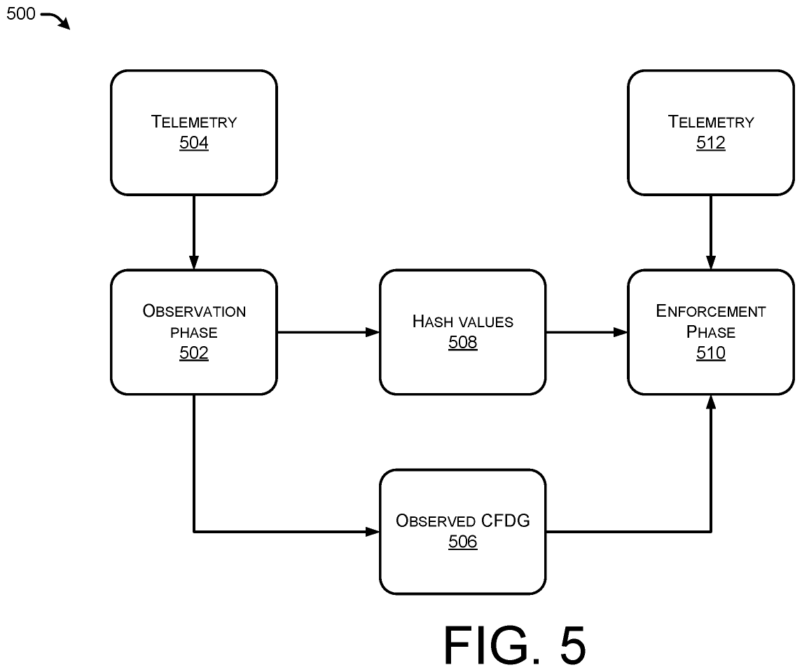

FIG. 5 illustrates an example of a process 500 for generating a hash for filtering control flow execution sequences, according to at least one execution example. The process 500, as illustrated, includes a representation of the observation phase 502. The observation phase 502 may be a phase that a computing system, such as described herein, is in during observation of application executions. The observation phase 502 is based on received telemetry 504, as discussed herein. During the observation phase 502, the computing system(s) build an observed CFDG 506, as discussed herein. The observed CFDG 506 is then used by the computing system(s) when in the enforcement phase 510 to enforce the transitions of the observed CFDG 506 as described by telemetry 512, as discussed herein. Additionally, during the observation phase 502, the hash tables described herein may be generated.

After the observation phase 502, a typical application execution will most likely follow one or more of the same major paths. In some examples, a hardware assistance engine may be used to calculate a rolling hash token for these major path transitions. This may compress a sequence of transitions into a smaller group for processing rather than processing an entire set of sequences. During the observation phase 502, and/or during the enforcement phase 510, the monitoring and enforcement engine may build a table of hash values (e.g., hash values 508)) for such major paths. Subsequently, a filter running in either hardware or software may verify or compare the hash values during execution from the rolling hash against the table stored at the hash values 508 to speed up the monitoring of executions. This improvement enhances the performance of the monitoring and enforcement engine by capitalizing on the fact that under normal circumstances applications will be traversing a small number of repeated and valid subgraphs.

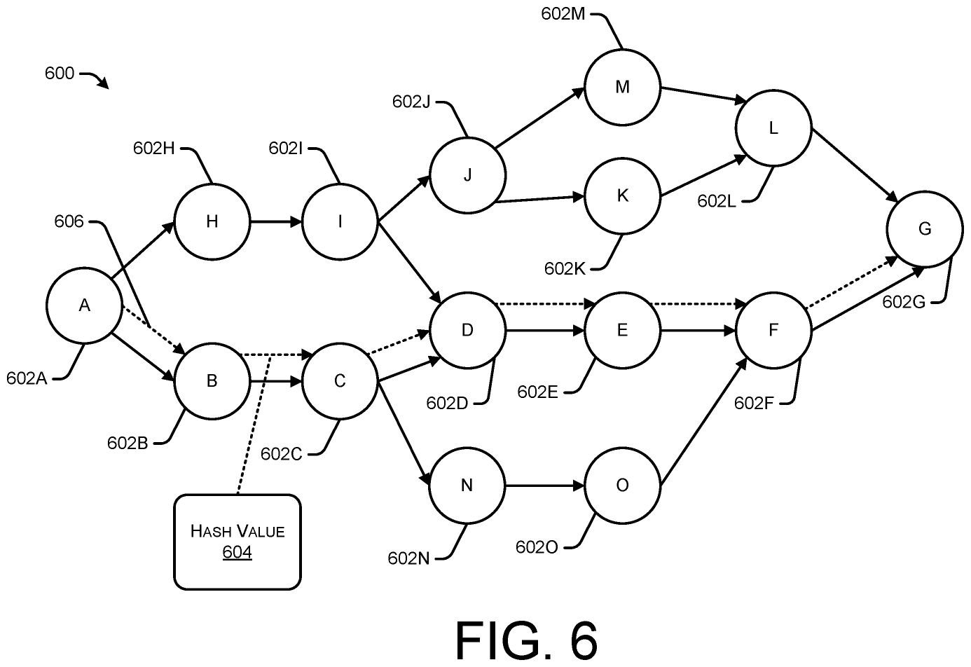

FIG. 6 illustrates an example of a control flow graph 600 showing a vector 606 execution with an associated hash value 604 for accelerating enforcement of the control flow graph, according to at least one execution example. The control flow graph 600 is a representation, using graph notation, of control flow, i.e., execution, paths that may be traversed through an application during execution of the application. In the control flow graph 600, each node 602A-6020 in the graph corresponds to a basic block. A basic block is a sequence of instructions where control enters only at the beginning of the sequence and control may leave only at the end of the sequence. In some examples, multiple transfers may begin from the same starting point. There is no branching in or out in the middle of a basic block. For example, a destination address, may correspond to a start of a basic block and an indirect branch instruction may correspond to an end of the block. An address of the indirect branch instruction may correspond to a source address. In some examples, binary analysis may be used to identify the address, therefore a previous address from an observed transition may be stored and become the source for the transition. A target address of the indirect branch instruction may correspond to a next possible address of a next basic block in the control flow graph 600, e.g., may correspond to a beginning address of a next/reachable basic block in the control flow graph 600. Edges between two basic blocks (e.g., a first block and a second block) represent control flow transfer to the beginning of the second block. A node may thus include a start address of the basic block, and a next possible start address of a next basic block i.e., a beginning address of a next/reachable basic block. The node may have a list of valid transitions, edges of the graph defining addresses where the flow may proceed, therefore each node has its own address and a list of destinations to which a valid transfer may be completed. The control flow graph 600 may be generated by, for example, source code analysis, binary analysis, static binary analysis, execution profiling, etc. The control flow graph may then include a plurality of legitimate execution paths. Each legitimate execution path may include a plurality of nodes connected by one or more edges.

The control flow graph 600 may be an example of the CFDG that is observed and use for enforcement as described herein. In some examples, the control flow graph 600 may be stored in a Bloom Filter, hash table, binary tree, or other fast access data structure. In some examples, non-graph structures may store address pairs of origins and destinations such that the data structure may be queried to determine validity of any transition. In some examples, the whole control flow graph 600 may be stored in the CPU cache or in memory accessible by the CPU. In some examples, only a subset of the control flow graph 600 may be stored using a sliding window algorithm. Accordingly, the subset of the control flow graph 600 includes all the directly reachable nodes from the current instruction at a node 602A, plus a predetermine number of child nodes that may be configured according to preferences. As the CPU instructions move through the control flow graph 600, for example from node 602A to node 602B, a refresh of the subset may be determined based on the full control flow graph 600 to include newly reachable nodes and child nodes. The control flow graph 600 may include indications of nodes that the CPU instructions processed, as well as accessible branches that were not processed but are available (child nodes). As the CPU executes instructions, for example from node 602A to 602B, the CPU looks to see if enough node-depth remains in the subset of the control flow graph 600 and if it reaches some threshold (e.g., must-be-two-nodes deep), it automatically updates its cache with a new subgraph from the original control flow graph 600 to meet those constraints.

In the control flow graph 600, during the observation phase and/or monitoring phase, the system may identify that a sequence, such as from node 602A to node 602G, specifically following the sequence: node 602A-node 602B-node 602C-node 602D-node 602E-node 602F-node 602G may be traversed frequently during execution of the application represented by the control flow graph 600. Accordingly, the vector 606 representing the sequence may have an associated hash value 604 that is stored in a hash table. Subsequently, during processing of telemetry, the system may identify, as described herein, a sequence from node 602A to node 602G with a hash value that matches the hash value 604. Accordingly, the system may identify the full sequence as verified according to the control flow graph 600.

In an example, when processing the telemetry and matching against the observed control flow graph there are two stages of processing that occur. A first stage is a decoding stage where telemetry packets are decoded from a stream of packets. During the decoding stage, information about the instruction pointer transition is acquired in a form of a tuple of two virtual addresses that correspond to source (FROM) and destination (TO) of the transition. A second stage includes checking the validity of (FROM, TO) a transition by looking up the addresses in the observed control flow graph. For all valid transitions there is an edge in the control flow graph 600 that connects source and destination of the transition (e.g., from node 602A to node 602G). By accelerating the lookup and checking of validity of a transition, as described herein, the entire process for monitoring and enforcing the control flow graph 600 is accelerated.

In the example, each lookup in the control flow graph 600 may be an expensive operation (e.g., expensive with respect to time and computing resources). Checking the presence of the edge requires de-referencing a pointer or making a lookup in a hash table. Considering the large number of edges, this operation may require looking into memory that is not loaded in cache. Based on the large number of transitions per second in any given application, it would considerably slow down the processing to look up all of the edges.

To accelerate the processing, the number of lookups per transition is reduced. Using the observed control flow graph 600, the system may identify that some paths in the control flow are traversed more frequently than others. Therefore, looking up the entire paths instead of a singular transition decreases the number of lookups per transition in the control flow, and thereby increases the speed of monitoring and enforcement.

In the example, the CPU may report a sequence of instruction addresses, A₁, A₂, . . . , A_{M}, that represent instructions from node 602A to node 602G. These addresses correspond to M−1 transitions: (A₁→A₂), (A₂→A₃), . . . , (A_{M-1}, →A_{M}). Each subsequence of sequence of addresses is also a valid sequence. The monitoring and enforcement engine may verify sequences of size 2, which correspond to a single transition. Increasing size of the sequence reduces the number of hash table lookups and thereby increases the speed of monitoring and enforcement.

During observation phase, the system may count all subsequences and compute their associated hash. Due to memory limitations and reduced effectiveness for very long sequences, in some examples the maximum length of the subsequence may be limited to some finite number greater than two. When the observation phase is finished, subsequence counts are used to compute probability distribution of subsequences given the size of the subsequence: P([Aᵢ_{₁}, Aᵢ_{₂}, . . . , Aᵢ_{_{N}}]|N), where N is the size of subsequence, 2≤N≤L. The probability distribution determined based on the start node of the sequence can be computed using equation Error! Reference source not found, reproduced below.

$$P ( [ {A}_{start} , {A}_{{i}_{2}} , … , {A}_{{i}_{N}} ] \vert {A}_{start} , N ) = \frac{P ( [ {A}_{start ,} {A}_{{i}_{2}} , … , {A}_{{i}_{N}} ] \vert N )}{\sum {∀}_{{j}_{2 , … , {j}_{N}}} P ( [ {A}_{start ,} {A}_{{j}_{2}} , … , {A}_{{j}_{N}} ] \vert N )} \qquad ( 4 )$$

The probability distribution may be further reduced to a probability distribution of hashes of a sequence conditioned on start address and size of sequence as shown in equation (2) reproduced below.

$$P ( hash \vert {A}_{start} , N ) = P ( hash ( [ {A}_{start} , {A}_{{i}_{2}} , … , {A}_{{i}_{N}} ] ) \vert {A}_{start} , N ) = P ( [ {A}_{start} , {A}_{{i}_{2}} , … , {A}_{{i}_{N}} ] \vert {A}_{start} , N ) \qquad ( 5 )$$

Using the probability distribution, the most likely set of hashes can be determined based on a combination of start address and sequence size. The most likely set of hashes (LikelyHash_{S}(Aₛₜₐᵣₜ,N)) can be arranged in an array of hashes with the likelihood of sequences that start with a particular address is distribution, the most likely hashes can be calculated for each combination of start address, Aₛₜₐᵣₜ, and have sequence size of N. The array may be arranged with the sequence having the greatest likelihood entered first, and proceed with decreasing probability

A hash table that may be compared against the hash value 604, AddressStat, may be constructed that maps start nodes, Aₛₜₐᵣₜ, to likely hashes of sequences starting with Aₛₜₐᵣₜ and a list of addresses immediately reachable from Aₛₜₐᵣₜ as shown in equation (3), reproduced below.

$$AddressStat [ {A}_{start} ] \to \{ \begin{matrix}\begin{matrix}\begin{matrix}[ {LikelyHash}_{S} ( {A}_{start} , L ) , \\ {LikelyHash}_{S} ( {A}_{start} , L - 1 ) , … ,\end{matrix} \\ {LikelyHash}_{S} ( {A}_{start} , 2 ) ]\end{matrix} \\ \{ {A}_{neighbor} \vert P ( [ {A}_{start} , {A}_{neighbour} ] ) > 0 \}\end{matrix} \qquad ( 6 )$$

In equation (3), the S and L are parameters of the algorithm and are fixed for the entire algorithm.

During the enforcement phase, a sequence of addresses may arrive at the monitoring and enforcement engine, A₁, A₂, . . . , A_{M}, representing the transitions from node 602A to node 602G, and the system may verify the validity of the sequence of addresses. To verify the validity of the sequence, the addresses may be processed in chunks of size L. Once addresses are processed up to a particular address, Aₜ, then only addresses following will require verification, such as Aₜ, Aₜ₊₁, . . . , A_{M}. Accordingly, the system may compute L−1 hashes of subsequences that start with Aₜ by gradually increasing the size of the subsequence up to L, to produce a set of hashes of subsequences,

$$hash ( [ {A}_{t} , {A}_{t + 1} ] ) , hash ( [ {A}_{t} , {A}_{t + 1} , {A}_{t + 2} ] ) , \text{} … , hash ( [ {A}_{t} , {A}_{t + 1} , … , {A}_{t + L} ] ) .$$

Subsequently, by doing a lookup in the AddressStat for key Aₜ, a set of likely hashes based on the start address and various sequence lengths can be produced. Iterating a sequence length k from longest L to shortest 2, the system may then check if hash([Aₜ, Aₜ₊₁, . . . , Aₜ₊ₖ]) is present in array of likely hashes LikelyHash_{S}(Aₜ,k). If the system is able to identify such a hash, then the system may stop iterating. If such hash was found by the system, then it is possible to skip verification of all the nodes between Aₜ and Aₜ₊ₖ because the path that connects those was encountered during observation and is identified based on the hash value. Accordingly, the system may mark all addresses before Aₜ₊ₖ as processed and repeat the above algorithm with the remaining unprocessed transitions.

Instead, if the hash value 604 does not match the stored value in the hash table, then the sequence of transitions may not follow vector 606 but may instead follow other branches outside of the major transitions to reach node 602G. Accordingly, if such a hash was not found after all iterations, the system may check if the transition [Aₜ, Aₜ₊₁] (e.g., from 602A to 602B) exists using the information received from AddressStat. If Aₜ₊₁ is in the list {A_{neighbour}|P([Aₜ,A_{neighbour}])>0} that contains all destinations that might validly, then the transition is valid. In this example, Aₜ may correspond to 602A and the list may contain all destinations immediately reachable from 602A, including 602B and 602H in this particular example. The system may then mark Aₜ as processed and repeat the algorithm for addresses after Aₜ₊₁. If, instead, Aₜ₊₁ is not found in the list, then it is invalid and the system will report the transition as invalid, stop the transition, or perform other enforcement actions as described herein.

In some instances, the example described herein may use a single hash table lookup for each L transition. In some instances, the number of look ups may be equal to the number transitions.

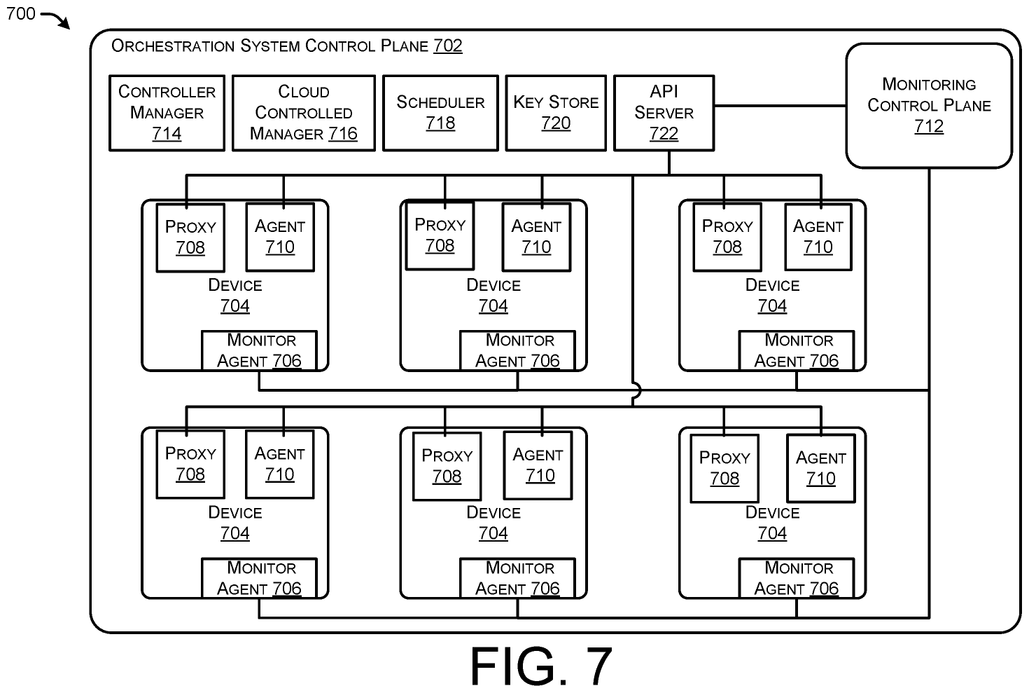

FIG. 7 illustrates a system architecture 700 for distributed monitoring agents on devices of a network or system with a centralized monitoring control plane, according to at least one example. In the system architecture 700, an orchestration system control plane 702 may provide monitoring for multiple devices and/or systems across a local, distributed, or cloud-based network. In the system architecture 700, devices 704 are connected to an API server 722 through proxy 708 and agent 710 components to orchestrate the functions of the devices 704 and/or to manage interactions between the devices 704. A controller manager 714 may include a control plan component that runs controller processes. Each controller may be a separate process, but a single binary may include a compilation of processes run in a single process. The cloud-controlled manager 716 includes a component that embeds cloud-specific control logic that enables links between the cluster into the API. The scheduler 718 may watch for newly created pods or devices with no assigned node and selects a node for them to run on. The key store 720 may be a distributed database that manages the configuration of the cluster and stores the state of the system.

A monitoring control plane 712 may be similar to the control center 102 and/or the monitoring agent 304. The monitoring control plane 712 may communicate with monitor agents 706 at each of the devices 704 that provide monitoring and enforcement as described herein. In this manner, individual monitor agents 706 may be deployed in a network that communicate alerts with the monitoring control plane 712 for coordinating the observed CFDG across the network of devices 704.

The monitoring control plane 712 may be configured to coordinate transitioning between observation and monitoring of the agents 706. For instance, the monitoring control plane 712 may cause a transition from observation to enforcement based on parallel observations, for example in an application that is running on multiple agents 706. The monitoring control plane 712 may aggregate results of observations from the agents 706 (or other distributed systems) and determine when the total coverage observed across all nodes has reached the operator defined confidence score threshold.

In such examples there may be overlapping results from the different agents 706. However, by aggregating the results, it may result in acceleration of the coverage, by observation, of the code to the threshold confidence score. If overlapping results, e.g., results from similar code segments operating at different agents 706, do not match or point to different transitions, then a consensus algorithm may be used to find the plurality of results that match (e.g., if 5 of 8 nodes have the same results, the system uses the outcome from the 5 nodes).

In some examples, the monitoring control plane 712 may include a policy-driven sub-system that analyzes the underlying code and delegates sections of the code to specific compute agents 706 to observe and analyze. This sub-system would also be responsible for compiling the analysis results from across the agents 706 and assembling the aggregate CFDG based on these observations across the agents 706. In this example, the monitoring control plane 712 pre-emptively divides the underlying code and assigns regions of the binary to different agents 706. The system then aggregates the results from observation at each of the agents 706 for their assigned portions of the binary. In this manner, the monitoring control plane 712 may reduce overlap and duplication of observations. In some examples, the assignment may include overlap, for example to ensure consistent results at different nodes. In a particular example, the central system may aggregate 25% of the binary from node A, and 30% from node B, with a 10% overlap or intersection between the two. Therefore, between nodes A and B, the system has aggregated observations of 45% of the binary. The transition decision from observation to enforcement can still be based on the confidence score, though the confidence score would be based on the aggregated results.

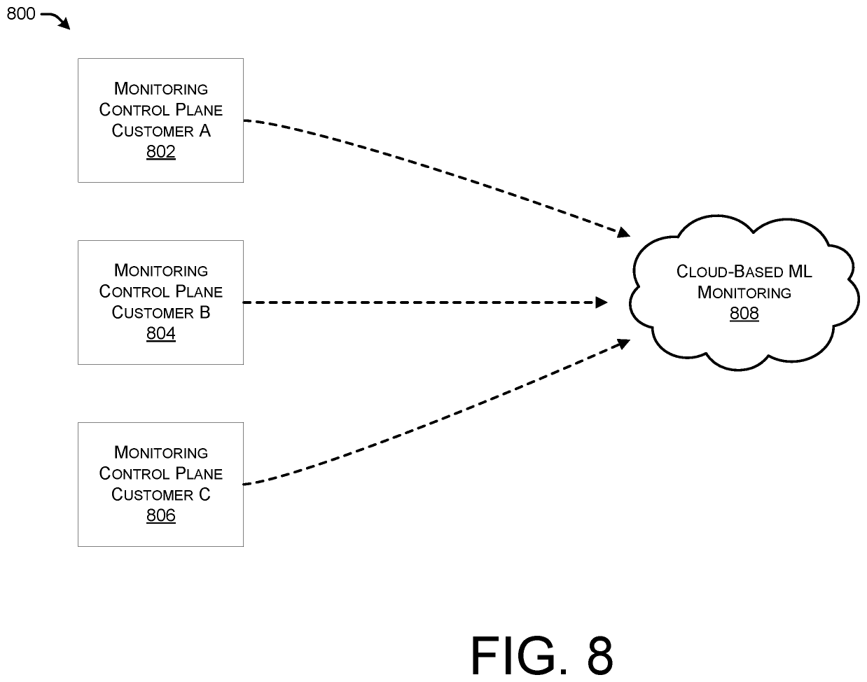

FIG. 8 illustrates an example of multiple different monitoring control planes reporting to a centralized cloud-based system for identifying large-scale patterns and exploits, according to at least one example. The control planes from multiple different customers 802, 804, and 806 are shown reporting to a centralized system for cloud-based machine learning monitoring 808. The control planes for individual customers 802, 804, and 806 may include the control plane described with respect to FIG. 7 that has insights within a particular organizational structure. However, the use of the cloud-based ML monitoring 808 may enable identification of vulnerabilities and exploits that extend outside of an organization and is targeted at a particular industry or region. In some examples, this would also aid in identifying variations of a particular exploit that may be used to run different code gadgets to bypass detection by typical signature-based approaches as the exact sequence may not match.

The cloud-based ML monitoring 808 may include one or more models and/or systems to aggregate observation data across organizational boundaries, between different organizational structures, as well as potentially across computing nodes as described herein. The observation phase may be spread across different organizations (e.g., customers 802, 804, and 806) and aggregated at the cloud-based ML monitoring 808. The organizations may be enabled to join the aggregation (e.g., opt-in) to the system to accelerate the observation phase and transition to monitoring. The opt-in from different organizations may include conveying from the different organizations, execution data without any identifying information or confidential information included therein. In some examples the data regarding observed executions may be scrubbed prior to conveying to the system of such information.

In some examples, the CFDG represents the application execution flow in real time. By combining this context with other Indicators of Compromise (IOCs), valuable insights can be delivered to one or more customers across industries. In some examples, distributed monitoring agents may be running the techniques and systems described herein to monitor and enforce application control flow integrity. In some examples, a centralized control plane may be used to manage monitor agents monitoring CPU telemetry in a distributed environment. The control plane may have a birds-eye overview of expected and observed behavior within a given organizational environment. Accordingly, the control plan can provide real-time view of any zero-day attacks happening within an organization. Additionally, the insights may be provided to security operators in real time. In some examples, the control plane may be used to share such real-time zero-day attack information with industry peers, as an early warning system for newly observed attacks in-progress. To this end, the control plane may anonymously send a report of a given observed attack to a cloud-based machine-learning system for sharing this information with industry peers.

In some examples, the customer reports would include general details about the given customer, to facilitate industry peer comparisons. For example, such reports may include (but are not limited to) customer industry, customer size, geographic location of incident(s), application affected, affected system types (e.g., bare-metal systems, VMs, containers, operating systems, versions, etc.), and other such information. Security operators could use the report data to perform industry peer comparisons to identify similar issues within their own environments, to help zero in on the root cause of the exploit. Such peer comparisons could be aligned vertically (according to industry type) or horizontally (by systems) and could answer critical questions such as (i) are other companies in a similar or identical industry vertical (e.g., financials, manufacturers, retailers, etc.) running this application/workload seeing the same anomalous behavior that I am? Additionally, the reports may help to identify if (ii) other companies running a similar or identical version of this application/workload seeing the same anomalous behavior that I am? In some examples, a specific application and/or version that may be targeted can be identified and the system could immediately report these findings to the application software vendor. In some examples, the analysis could be reported as an Indicator of Compromise (IOC) for publishing via the standard IOC pub-protocol.

In some examples, as the geographic location of affected systems could also being reported to the system, and the location information could likewise be shared with industry peers to show how the attack is progressing—in real time—by geographic regions. Such analysis and information may aid in identifying an origin of the attack, spread of the attack, how fast the attack is spreading, and other such information.

Additionally, the system could also feed information back to control planes in given customer locations so that policies could be dynamically enabled to automatically adapt to the attack in progress. For example, the policies may include (but are not limited to) pre-emptively enforcing a more stringent policy for evaluating unknown transitions, accelerating the observation/learning process by looking for outliers only and applying the CFDG, pre-emptively changing the enforcement policies to advance from a more lenient policy (such as alerting-only) to a more strict policy (such as automatic application termination when a violation is detected), pre-emptively changing the confidence score threshold to a lower value so as to more quickly transition from the observation phase to the enforcement phase, or to immediately advance to the enforcement phase from the observation phase.

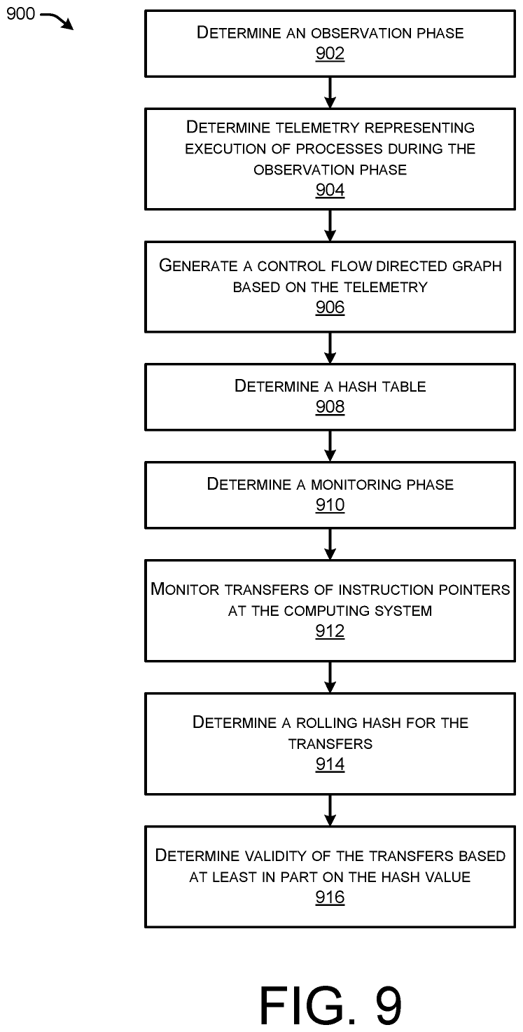

FIG. 9 illustrates a process for observing, monitoring, providing enforcement, and reporting on execution of applications and workloads on computing device. The processes described herein are illustrated as collections of blocks in logical flow diagrams, which represent a sequence of operations, some, or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed.

FIG. 9 illustrates an example process 900 for enforcing execution according to an observed control flow directed graph, according to at least one example. At 902, the process 900 may include determining an observation phase for observing execution of processes on the computing system. Determining the observation phase may include determining a predetermined observation time window to observe transitions by an application or a predetermined code percentage to observe. In some examples, the observation time window may be a set number of minutes, days, second, etc. In some examples, the observation phase may include a period of time until a threshold amount of the code is observed executing. The threshold amount may include a percentage of the code and may be configurable by a security operations center.

At 904, the process 900 may include collecting and/or determining telemetry, during the observation phase, representing execution of the processes. The telemetry may include central processing unit (CPU) telemetry. The telemetry may indicate instructions executed by the CPU and may include O/S telemetry and/or telemetry from other sources such as VMs, containers, bare-metal, and other such sources. Determining the telemetry may include determining whether the processes are running on a computing device or within a virtual machine.

At 906, the process 900 may include generating a control flow directed graph based on the telemetry. In some examples, the control flow directed graph may be generated by normalizing the CPU telemetry into a control flow directed graph representation that may be understood by a variety of different devices and systems. Generating the control flow directed graph may be based on observed transfers during the observation phase, where the observed transfers during the observation phase are considered valid transfers.

At 908, the process 900 may include determining a hash table or other data structure that stores or contains hash values based on the observation phase. In the control flow graph, during the observation phase and/or monitoring phase, the system may identify that a sequence may be traversed frequently during execution of the application represented by the control flow graph. Accordingly, a vector representing the sequence may have an associated hash value that is stored in a hash table. Subsequently, during processing of telemetry, the system may identify, as described herein, a sequence of transfers with a hash value that matches the hash value. Accordingly, the system may identify the full sequence as verified according to the control flow graph.

In an example, when processing the telemetry and matching against the observed control flow graph there are two stages of processing that occur. A first stage is a decoding stage where telemetry packets are decoded from a stream of packets. During the decoding stage, information about the instruction pointer transition is acquired in a form of a tuple of two virtual addresses that correspond to source (FROM) and destination (TO) of the transition. A second stage includes checking the validity of (FROM, TO) a transition by looking up the addresses in the observed control flow graph. For all valid transitions there is an edge in the control flow graph that connects source and destination of the transition. By accelerating the lookup and checking of validity of a transition, as described herein, the entire process for monitoring and enforcing the control flow graph is accelerated.

At 910, the process 900 may include determining a monitoring or enforcement phase based at least in part on the control flow directed graph. Determining the monitoring phase may include determining completion of the observation phase based at least in part on the control flow directed graph representing at least a threshold of application processes. In some examples, the monitoring phase may begin based on expiration of a time period for the observation phase and/or an instruction from a security center to begin the monitoring phase.

At 912, the process 900 may include monitoring transfers of instruction pointers at the computing system. The monitoring phase may be performed using a hardware device of the computing system and where determining the invalid transfer is based at least in part on identifying an instruction sequence in the CPU telemetry that is not present in the control flow directed graph.

In some examples, the system may leverage specific policies to allow or enable executions of unobserved transitions during the monitoring phase, thereby enabling the system to transition to monitoring executions sooner (e.g., to allow a lower observed percentage or lower confidence score). The policies may be established such that an incomplete observation would not necessarily exclude execution of a particular transition. In an example, a time window may be determined that allows the executions (unobserved) to continue to execute while the underlying code (binary) is evaluated by one or more other systems to determine a risk score and/or potential for exploits through the underlying code that is unobserved. The evaluation may be performed by an analyst, machine learning model, algorithm, code analyzer, software bill of materials analysis, or other such analysis. Additional policy enforcements may be implemented, such as policies that specify restrictions on new network connections that would prevent lateral movement through the unobserved transitions.

At 914, the process 900 may include determining a rolling hash for the transfers. The rolling hash may include a rolling value that is appended with a hash value associated with each of the different transitions included in the sequence of transfers. In some instances, a portion of the rolling hash may be selected and/or identified as corresponding with a frequently traversed set of transfers executed by the system.

At 916, the process 900 may include determining validity of one or more transfers based at least in part on the control flow directed graph. The invalid transfer may be identified based on not being included within the CFDG. In some examples, the invalid transfer may be communicated in an alert to a security operations center of a facility operating the computing device and/or to a source of the application or process including the transfer. The invalid transfer may be determined based on determining a transfer of an instruction pointer, comparing the transfer against the control flow directed graph, determining the transfer is not present in the control flow directed graph, and determining the transfer is the invalid transfer. Determining the invalid transfer may include inputting the transfers of instruction pointers into a machine learning model trained to identify invalid transfers based at least in part on transfers included in the control flow directed graph. The system may include reporting the invalid transfer to cloud-based system for monitoring one or more computing systems. As described herein, based on the hash value for the sequence matching the hash value stored in the table from the observation phase (or monitoring phase), the entire sequence may be identified as valid, rather than individually validating each step in the sequence.

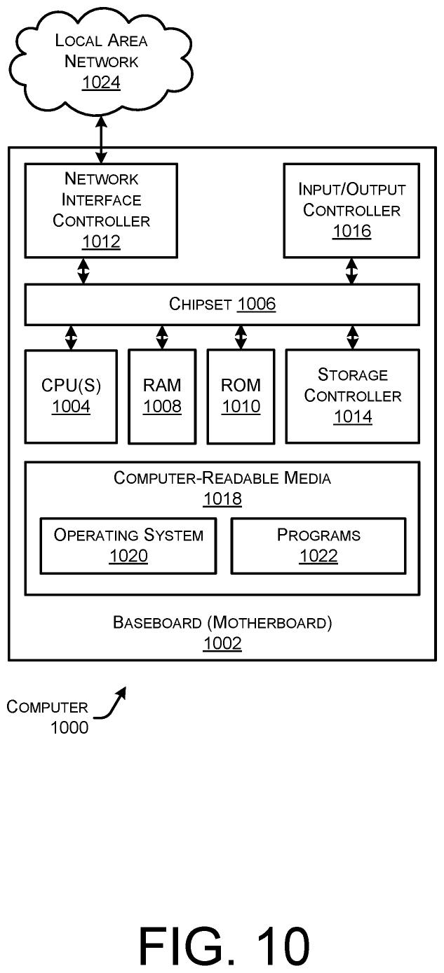

FIG. 10 is an architecture diagram for a computer 1000 showing an illustrative computer hardware architecture for implementing a computing device that can be utilized to implement aspects of the various technologies presented herein. The computer architecture shown in FIG. 10 illustrates a conventional server computer, workstation, desktop computer, laptop, tablet, network appliance, e-reader, smartphone, or other computing device, and can be utilized to execute any of the software components presented herein. In some examples, the computer 1000 may be part of a system of computers, such as the local area network 1024 or other such devices described herein. In some instances, the computer 1000 may be included in a system of devices that perform the operations described herein.

The computer 1000 includes a baseboard 1002, or “motherboard,” which is a printed circuit board to which a multitude of components or devices can be connected by way of a system bus or other electrical communication paths. In one illustrative configuration, one or more central processing units (“CPUs 1004”) operate in conjunction with a chipset 1006. The CPUs 1004 can be standard programmable processors that perform arithmetic and logical operations necessary for the operation of the computer 1000.

The CPUs 1004 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1006 provides an interface between the CPUs 1004 and the remainder of the components and devices on the baseboard 1002. The chipset 1006 can provide an interface to a RAM 1008, used as the main memory in the computer 1000. The chipset 1006 can further provide an interface to a computer-readable storage media 1018 such as a read-only memory (“ROM 1010”) or non-volatile RAM (“NVRAM”) for storing basic routines that help to startup the computer 1000 and to transfer information between the various components and devices. The ROM 1010 or NVRAM can also store other software components necessary for the operation of the computer 1000 in accordance with the configurations described herein.

The computer 1000 can operate in a networked environment using logical connections to remote computing devices and computer systems through a network, such as the local area network 1024 or other networks, including for example the internet. The chipset 1006 can include functionality for providing network connectivity through a network interface controller (“NIC 1012”), such as a gigabit Ethernet adapter. The NIC 1012 is capable of connecting the computer 1000 to other computing devices over the local area network 1024. It should be appreciated that multiple NICs can be present in the computer 1000, connecting the computer to other types of networks and remote computer systems.

The computer 1000 can include storage 1014 (e.g., disk) that provides non-volatile storage for the computer. The storage 1014 can consist of one or more physical storage units. The storage 1014 can store information by altering the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1000 can further read information from the storage 1014 by detecting the physical states or characteristics of one or more particular locations within the physical storage units.

In addition to the storage 1014 described above, the computer 1000 can have access to other computer-readable storage media 1018 to store and retrieve information, such as programs 1022, operating system 1020, data structures, or other data. It should be appreciated by those skilled in the art that computer-readable storage media 1018 is any available media that provides for the non-transitory storage of data and that can be accessed by the computer 1000. Some or all of the operations performed by any components included therein, may be performed by one or more computer(s) 1000 operating in a network-based arrangement.

By way of example, and not limitation, computer-readable storage media 1018 can include volatile and non-volatile, removable, and non-removable media implemented in any method or technology. Computer-readable storage media 1018 includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The computer-readable storage media 1018 can store an operating system 1020 utilized to control the operation of the computer 1000. According to one embodiment, the operating system comprises the LINUX operating system. According to another embodiment, the operating system comprises the WINDOWS SERVER operating system from MICROSOFT Corporation of Redmond, Washington. According to further embodiments, the operating system can comprise the UNIX operating system or one of its variants. It should be appreciated that other operating systems can also be utilized. The computer-readable storage media 1018 can store other system or programs 1022 and data utilized by the computer 1000.

In one embodiment, the computer-readable storage media 1018, storage 1014, RAM 1008, ROM 1010, and/or other computer-readable storage media may be encoded with computer-executable instructions which, when loaded into the computer 1000, transform the computer from a general-purpose computing system into a special-purpose computer capable of implementing the embodiments described herein. These computer-executable instructions transform the computer 1000 by specifying how the CPUs 1004 transition between states, as described above. According to one embodiment, the computer 1000 has access to computer-readable storage media storing computer-executable instructions which, when executed by the computer 1000, perform the various techniques described above. The computer 1000 can also include computer-readable storage media having instructions stored thereupon for performing any of the other computer-implemented operations described herein.

The computer 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can provide output to a display, such as a computer monitor, a flat-panel display, a digital projector, a printer, or other type of output device. It will be appreciated that the computer 1000 might not include all of the components shown in FIG. 10, can include other components that are not explicitly shown in FIG. 10, or might utilize an architecture completely different than that shown in FIG. 10.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for monitoring a computing system, comprising:
determining an observation phase for observing execution of processes on the computing system;
determining telemetry, during the observation phase, representing execution of the processes;
generating a control flow directed graph representing execution sequences of an application based on the telemetry;
determining a hash table with entries representing hash values for sequences of transitions within the control flow directed graph;
determining a monitoring phase based at least in part on the control flow directed graph;
monitoring transfers of instruction pointers at the computing system;
determining a rolling hash associated with the transfers; and
determining a validity of the transfers based at least in part on the rolling hash and the hash table.

2. The method of claim 1, wherein determining the validity of the transfers comprises:
determining a sequence of multiple transfers;
determining a hash value of the rolling hash associated with the sequence of transfers; and
determining that the sequence of multiple transfers is valid based on the hash value corresponding to an entry of the hash table.

3. The method of claim 1, wherein generating the control flow directed graph is based on observed transfers during the observation phase, wherein the observed transfers during the observation phase are considered valid transfers.

4. The method of claim 1, wherein determining the hash table comprises:
determining one or more sequences of transitions based at least in part on the one or more sequences being traversed over a threshold number of times during the observation phase; and
determining one or more hash values associated with the one or more sequences.

5. The method of claim 1, wherein determining the validity of the transfers comprises:
determining a set of hash values from the hash table based on a start position within the control flow directed graph;
determining a subset of the set of hash values based on a number of transitions included within the transfers; and
determining the validity based on a subset of the rolling hash associated with the transfers corresponding to a hash value of the subset of the set of hash values.

6. The method of claim 1, wherein the telemetry comprises central processing unit (CPU) telemetry, and wherein generating the control flow directed graph comprises normalizing the CPU telemetry into a control flow directed graph representation.

7. The method of claim 6, wherein the monitoring phase is performed using a hardware device of the computing system and wherein determining the validity is based at least in part on identifying an instruction sequence in the CPU telemetry that is not present in the control flow directed graph.

8. A system comprising:
one or more processors; and
one or more non-transitory computer-readable media storing computer-executable instructions that, when executed by the one or more processors, cause the one or more processors to perform operations comprising:
determining an observation phase for observing execution of processes on a computing system;
determining telemetry, during the observation phase, representing execution of the processes;
generating a control flow directed graph representing execution sequences of an application based on the telemetry;
determining a hash table with entries representing hash values for sequences of transitions within the control flow directed graph;
determining a monitoring phase based at least in part on the control flow directed graph;
monitoring transfers of instruction pointers at the computing system;
determining a rolling hash associated with the transfers; and
determining a validity of the transfers based at least in part on the rolling hash and the hash table.

9. The system of claim 8, wherein determining the validity of the transfers comprises:
determining a sequence of multiple transfers;
determining a hash value of the rolling hash associated with the sequence of transfers; and
determining that the sequence of multiple transfers is valid based on the hash value corresponding to an entry of the hash table.

10. The system of claim 8, wherein determining the hash table comprises:
determining one or more sequences of transitions based at least in part on the one or more sequences being traversed over a threshold number of times during the observation phase; and
determining one or more hash values associated with the one or more sequences.

11. The system of claim 8, wherein generating the control flow directed graph is based on observed transfers during the observation phase, wherein the observed transfers during the observation phase are considered valid transfers.

12. The system of claim 8, wherein determining the validity of the transfers comprises:
determining a set of hash values from the hash table based on a start position within the control flow directed graph;
determining a subset of the set of hash values based on a number of transitions included within the transfers; and
determining the validity based on a subset of the rolling hash associated with the transfers corresponding to a hash value of the subset of the set of hash values.

13. The system of claim 8, wherein the telemetry comprises central processing unit (CPU) telemetry, and wherein generating the control flow directed graph comprises normalizing the CPU telemetry into a control flow directed graph representation.

14. The system of claim 13, wherein the monitoring phase is performed using a hardware device of the computing system and wherein determining the validity is based at least in part on identifying an instruction sequence in the CPU telemetry that is not present in the control flow directed graph.

15. One or more non-transitory computer-readable media storing computer-readable instructions that, when executed by one or more processors, cause the one or more processors to perform operations comprising:
determining an observation phase for observing execution of processes on a computing system;
determining telemetry, during the observation phase, representing execution of the processes;
generating a control flow directed graph representing execution sequences of an application based on the telemetry;
determining a hash table with entries representing hash values for sequences of transitions within the control flow directed graph;
determining a monitoring phase based at least in part on the control flow directed graph;
monitoring transfers of instruction pointers at the computing system;
determining a rolling hash associated with the transfers; and
determining a validity of the transfers based at least in part on the rolling hash and the hash table.

16. The one or more non-transitory computer-readable media of claim 15, wherein determining the validity of the transfers comprises:
determining a sequence of multiple transfers;
determining a hash value of the rolling hash associated with the sequence of transfers; and
determining that the sequence of multiple transfers is valid based on the hash value corresponding to an entry of the hash table.

17. The one or more non-transitory computer-readable media of claim 15, wherein determining the hash table comprises:
determining one or more sequences of transitions based at least in part on the one or more sequences being traversed over a threshold number of times during the observation phase; and
determining one or more hash values associated with the one or more sequences.

18. The one or more non-transitory computer-readable media of claim 15, wherein determining the validity of the transfers comprises:
determining a set of hash values from the hash table based on a start position within the control flow directed graph;
determining a subset of the set of hash values based on a number of transitions included within the transfers; and
determining the validity based on a subset of the rolling hash associated with the transfers corresponding to a hash value of the subset of the set of hash values.

19. The one or more non-transitory computer-readable media of claim 15, wherein the telemetry comprises central processing unit (CPU) telemetry, and wherein generating the control flow directed graph comprises normalizing the CPU telemetry into a control flow directed graph representation.

20. The one or more non-transitory computer-readable media of claim 19, wherein the monitoring phase is performed using a hardware device of a computing system and wherein determining the validity is based at least in part on identifying an instruction sequence in the CPU telemetry that is not present in the control flow directed graph.
